(19) United States
(12) Patent Application Publication
(10) Pub. No.: US 2026/0270683 A1
(43) Pub. Date: Sep. 10, 2026

(54) VALIDATION OF FUNCTIONALITIES ASSOCIATED WITH USER-EQUIPMENT-SIDE OPERATIONS

(71) Applicant: QUALCOMM Incorporated, San Diego, CA (US)

(72) Inventors: Qiaoyu LI, Beijing (CN); Mahmoud TAHERZADEH BOROUJENI, San Diego, CA (US); Hamed PEZESHKI, San Diego, CA (US)

(21) Appl. No.: 19/153,621

(22) PCT Filed: Apr. 7, 2023
(86) PCT No.: PCT/CN2023/086793

§ 371 Date: Aug. 5, 2025

(51) Int. Cl. H04W 8/24; H04W 72/231

(52) U.S. Cl. CPC H04W 8/24; H04W 72/231

(57) ABSTRACT

Various aspects of the present disclosure generally relate to wireless communication. In some aspects, a user equipment (UE) may transmit or receive one or more of: a UE capability report, a condition triggered functionality validation request, a network confirmation of a functionality validation, or a network rejection of the functionality validation, based at least in part on a functionality associated with a UE-side artificial intelligence or machine learning (AI/ML) operation. The UE may perform an action based at least in part on whether the functionality associated with the UE-side AI/ML operation is validated or invalidated in accordance with one or more of: the UE capability report, the condition triggered functionality validation request, the network confirmation of the functionality validation, or the network rejection of the functionality validation. Numerous other aspects are described.

### FIELD OF THE DISCLOSURE

Aspects of the present disclosure generally relate to wireless communication and to techniques and apparatuses for validation of functionalities associated with user-equipment-side operations.

### BACKGROUND

Wireless communication systems are widely deployed to provide various telecommunication services such as telephony, video, data, messaging, and broadcasts. Typical wireless communication systems may employ multiple-access technologies capable of supporting communication with multiple users by sharing available system resources (e.g., bandwidth, transmit power, or the like). Examples of such multiple-access technologies include code division multiple access (CDMA) systems, time division multiple access (TDMA) systems, frequency division multiple access (FDMA) systems, orthogonal frequency division multiple access (OFDMA) systems, single-carrier frequency division multiple access (SC-FDMA) systems, time division synchronous code division multiple access (TD-SCDMA) systems, and Long Term Evolution (LTE). LTE/LTE-Advanced is a set of enhancements to the Universal Mobile Telecommunications System (UMTS) mobile standard promulgated by the Third Generation Partnership Project (3GPP).

A wireless network may include one or more network nodes that support communication for wireless communication devices, such as a user equipment (UE) or multiple UEs. A UE may communicate with a network node via downlink communications and uplink communications. “Downlink” (or “DL”) refers to a communication link from the network node to the UE, and “uplink” (or “UL”) refers to a communication link from the UE to the network node. Some wireless networks may support device-to-device communication, such as via a local link (e.g., a sidelink (SL), a wireless local area network (WLAN) link, and/or a wireless personal area network (WPAN) link, among other examples).

The above multiple access technologies have been adopted in various telecommunication standards to provide a common protocol that enables different UEs to communicate on a municipal, national, regional, and/or global level. New Radio (NR), which may be referred to as 5G, is a set of enhancements to the LTE mobile standard promulgated by the 3GPP. NR is designed to better support mobile broadband internet access by improving spectral efficiency, lowering costs, improving services, making use of new spectrum, and better integrating with other open standards using orthogonal frequency division multiplexing (OFDM) with a cyclic prefix (CP) (CP-OFDM) on the downlink, using CP-OFDM and/or single-carrier frequency division multiplexing (SC-FDM) (also known as discrete Fourier transform spread OFDM (DFT-s-OFDM)) on the uplink, as well as supporting beamforming, multiple-input multiple-output (MIMO) antenna technology, and carrier aggregation. As the demand for mobile broadband access continues to increase, further improvements in LTE, NR, and other radio access technologies remain useful.

### SUMMARY

In some implementations, an apparatus for wireless communication at a user equipment (UE) includes a memory and one or more processors, coupled to the memory, configured to: transmit or receive one or more of: a UE capability report, a condition triggered functionality validation request, a network confirmation of a functionality validation, or a network rejection of the functionality validation, based at least in part on a functionality associated with a UE-side artificial intelligence or machine learning (AI/ML) operation; and perform an action based at least in part on whether the functionality associated with the UE-side AI/ML operation is validated or invalidated in accordance with one or more of: the UE capability report, the condition triggered functionality validation request, the network confirmation of the functionality validation, or the network rejection of the functionality validation.

In some implementations, an apparatus for wireless communication at a network node includes a memory and one or more processors, coupled to the memory, configured to: transmit or receive one or more of: a UE capability report, a condition triggered functionality validation request, a network confirmation of a functionality validation, or a network rejection of the functionality validation, based at least in part on a functionality associated with a UE-side AI/ML operation, and the functionality being validated or invalidated in accordance with one or more of: the UE capability report, the condition triggered functionality validation request, the network confirmation of the functionality validation, or the network rejection of the functionality validation.

In some implementations, a method of wireless communication performed by a UE includes transmitting or receiving one or more of: a UE capability report, a condition triggered functionality validation request, a network confirmation of a functionality validation, or a network rejection of the functionality validation, based at least in part on a functionality associated with a UE-side AI/ML operation; and performing an action based at least in part on whether the functionality associated with the UE-side AI/ML operation is validated or invalidated in accordance with one or more of: the UE capability report, the condition triggered functionality validation request, the network confirmation of the functionality validation, or the network rejection of the functionality validation.

In some implementations, a method of wireless communication performed by a network node includes transmitting or receiving one or more of: a UE capability report, a condition triggered functionality validation request, a network confirmation of a functionality validation, or a network rejection of the functionality validation, based at least in part on a functionality associated with a UE-side AI/ML operation, and the functionality being validated or invalidated in accordance with one or more of: the UE capability report, the condition triggered functionality validation request, the network confirmation of the functionality validation, or the network rejection of the functionality validation.

In some implementations, a non-transitory computer-readable medium storing a set of instructions for wireless communication includes one or more instructions that, when executed by one or more processors of a UE, cause the UE to: transmit or receive one or more of: a UE capability report, a condition triggered functionality validation request, a network confirmation of a functionality validation, or a network rejection of the functionality validation, based at least in part on a functionality associated with a UE-side AI/ML operation; and perform an action based at least in part on whether the functionality associated with the UE-side AI/ML operation is validated or invalidated in accordance with one or more of: the UE capability report, the condition triggered functionality validation request, the network confirmation of the functionality validation, or the network rejection of the functionality validation.

In some implementations, a non-transitory computer-readable medium storing a set of instructions for wireless communication includes one or more instructions that, when executed by one or more processors of a network node, cause the network node to: transmit or receive one or more of: a UE capability report, a condition triggered functionality validation request, a network confirmation of a functionality validation, or a network rejection of the functionality validation, based at least in part on a functionality associated with a UE-side AI/ML operation, and the functionality being validated or invalidated in accordance with one or more of: the UE capability report, the condition triggered functionality validation request, the network confirmation of the functionality validation, or the network rejection of the functionality validation.

In some implementations, an apparatus for wireless communication includes means for transmitting or receiving one or more of: an apparatus capability report, a condition triggered functionality validation request, a network confirmation of a functionality validation, or a network rejection of the functionality validation, based at least in part on a functionality associated with an apparatus-side AI/ML operation; and means for performing an action based at least in part on whether the functionality associated with the apparatus-side AI/ML operation is validated or invalidated in accordance with one or more of: the apparatus capability report, the condition triggered functionality validation request, the network confirmation of the functionality validation, or the network rejection of the functionality validation.

In some implementations, an apparatus for wireless communication includes means for transmitting or receiving one or more of: a UE capability report, a condition triggered functionality validation request, a network confirmation of a functionality validation, or a network rejection of the functionality validation, based at least in part on a functionality associated with a UE-side AI/ML operation, and the functionality being validated or invalidated in accordance with one or more of: the UE capability report, the condition triggered functionality validation request, the network confirmation of the functionality validation, or the network rejection of the functionality validation.

Aspects generally include a method, apparatus, system, computer program product, non-transitory computer-readable medium, user equipment, base station, network entity, network node, wireless communication device, and/or processing system as substantially described herein with reference to and as illustrated by the drawings and specification.

The foregoing has outlined rather broadly the features and technical advantages of examples according to the disclosure in order that the detailed description that follows may be better understood. Additional features and advantages will be described hereinafter. The conception and specific examples disclosed may be readily utilized as a basis for modifying or designing other structures for carrying out the same purposes of the present disclosure. Such equivalent constructions do not depart from the scope of the appended claims. Characteristics of the concepts disclosed herein, both their organization and method of operation, together with associated advantages, will be better understood from the following description when considered in connection with the accompanying figures. Each of the figures is provided for the purposes of illustration and description, and not as a definition of the limits of the claims.

While aspects are described in the present disclosure by illustration to some examples, those skilled in the art will understand that such aspects may be implemented in many different arrangements and scenarios. Techniques described herein may be implemented using different platform types, devices, systems, shapes, sizes, and/or packaging arrangements. For example, some aspects may be implemented via integrated chip embodiments or other non-module-component based devices (e.g., end-user devices, vehicles, communication devices, computing devices, industrial equipment, retail/purchasing devices, medical devices, and/or artificial intelligence devices). Aspects may be implemented in chip-level components, modular components, non-modular components, non-chip-level components, device-level components, and/or system-level components. Devices incorporating described aspects and features may include additional components and features for implementation and practice of claimed and described aspects. For example, transmission and reception of wireless signals may include one or more components for analog and digital purposes (e.g., hardware components including antennas, radio frequency (RF) chains, power amplifiers, modulators, buffers, processors, interleavers, adders, and/or summers). It is intended that aspects described herein may be practiced in a wide variety of devices, components, systems, distributed arrangements, and/or end-user devices of varying size, shape, and constitution.

### BRIEF DESCRIPTION OF THE DRAWINGS

So that the above-recited features of the present disclosure can be understood in detail, a more particular description, briefly summarized above, may be had by reference to aspects, some of which are illustrated in the appended drawings. It is to be noted, however, that the appended drawings illustrate only certain typical aspects of this disclosure and are therefore not to be considered limiting of its scope, for the description may admit to other equally effective aspects. The same reference numbers in different drawings may identify the same or similar elements.

FIG. 1 is a diagram illustrating an example of a wireless network, in accordance with the present disclosure.

FIG. 2 is a diagram illustrating an example of a network node in communication with a user equipment (UE) in a wireless network, in accordance with the present disclosure.

FIG. 3 is a diagram illustrating an example disaggregated base station architecture, in accordance with the present disclosure.

FIG. 4 is a diagram illustrating an example of beam management, in accordance with the present disclosure.

FIG. 5 is a diagram illustrating an example associated with validation of functionalities associated with UE-side operations, in accordance with the present disclosure.

FIGS. 6-7 are diagrams illustrating example processes associated with validation of functionalities associated with UE-side operations, in accordance with the present disclosure.

FIGS. 8-9 are diagrams of example apparatuses for wireless communication, in accordance with the present disclosure.

### DETAILED DESCRIPTION

A quantity of functionalities for an artificial intelligence (AI) and/or machine learning (ML) (AI/ML) based user equipment (UE) operation may be defined. A functionality may include a beam prediction, a channel state feedback (CSF), or a positioning. AI/ML functionalities may be validated (or activated) all of the time. A UE may constantly validate (or activate) the AI/ML functionalities, even when such AI/ML functionalities are not needed, which may waste resources (e.g., power, bandwidth, and/or processing) associated with the UE.

In some aspects described herein, the UE may transmit or receive, to or from a network node, respectively, a UE capability report, a condition triggered functionality validation request, a network confirmation of a functionality validation, and/or a network rejection of the functionality validation, based at least in part on a functionality associated with a UE-side AI/ML operation. The functionality associated with the UE-side AI/ML operation may be a time domain beam prediction, a spatial domain beam prediction, a frequency domain beam prediction, an AI/ML based channel state information (CSI) feedback, or an AI/ML based positioning. The UE may perform an action based at least in part on whether the functionality associated with the UE-side AI/ML operation is validated or invalidated in accordance with the UE capability report, the condition triggered functionality validation request, the network confirmation of the functionality validation, and/or the network rejection of the functionality validation.

The UE, when performing the action, may perform the functionality based at least in part on the functionality being validated. Alternatively, the UE, when performing the action, may refrain from performing the functionality based at least in part on the functionality being invalidated. As a result, the UE may selectively validate or invalidate AI/ML functionalities, which may conserve resources associated with the UE, and thereby improve a performance associated with the UE.

Various aspects of the disclosure are described more fully hereinafter with reference to the accompanying drawings. This disclosure may, however, be embodied in many different forms and should not be construed as limited to any specific structure or function presented throughout this disclosure. Rather, these aspects are provided so that this disclosure will be thorough and complete, and will fully convey the scope of the disclosure to those skilled in the art. One skilled in the art should appreciate that the scope of the disclosure is intended to cover any aspect of the disclosure disclosed herein, whether implemented independently of or combined with any other aspect of the disclosure. For example, an apparatus may be implemented or a method may be practiced using any number of the aspects set forth herein. In addition, the scope of the disclosure is intended to cover such an apparatus or method which is practiced using other structure, functionality, or structure and functionality in addition to or other than the various aspects of the disclosure set forth herein. It should be understood that any aspect of the disclosure disclosed herein may be embodied by one or more elements of a claim.

Several aspects of telecommunication systems will now be presented with reference to various apparatuses and techniques. These apparatuses and techniques will be described in the following detailed description and illustrated in the accompanying drawings by various blocks, modules, components, circuits, steps, processes, algorithms, or the like (collectively referred to as “elements”). These elements may be implemented using hardware, software, or combinations thereof. Whether such elements are implemented as hardware or software depends upon the particular application and design constraints imposed on the overall system.

While aspects may be described herein using terminology commonly associated with a 5G or New Radio (NR) radio access technology (RAT), aspects of the present disclosure can be applied to other RATs, such as a 3G RAT, a 4G RAT, and/or a RAT subsequent to 5G (e.g., 6G).

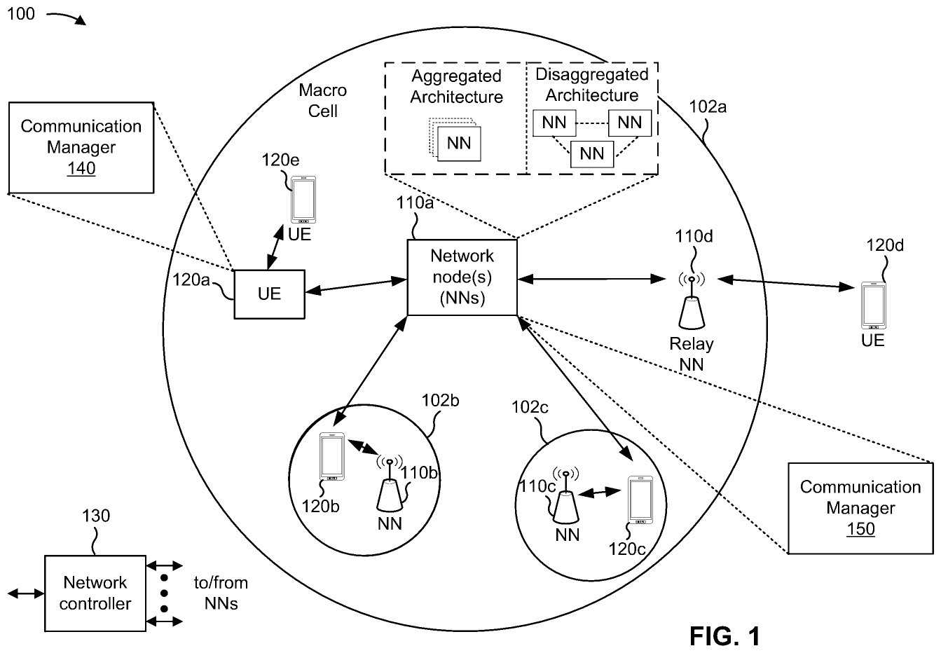

FIG. 1 is a diagram illustrating an example of a wireless network 100, in accordance with the present disclosure. The wireless network 100 may be or may include elements of a 5G (e.g., NR) network and/or a 4G (e.g., Long Term Evolution (LTE)) network, among other examples. The wireless network 100 may include one or more network nodes 110 (shown as a network node 110a, a network node 110b, a network node 110c, and a network node 110d), a UE 120 or multiple UEs 120 (shown as a UE 120a, a UE 120b, a UE 120c, a UE 120d, and a UE 120e), and/or other entities. A network node 110 is a network node that communicates with UEs 120. As shown, a network node 110 may include one or more network nodes. For example, a network node 110 may be an aggregated network node, meaning that the aggregated network node is configured to utilize a radio protocol stack that is physically or logically integrated within a single radio access network (RAN) node (e.g., within a single device or unit). As another example, a network node 110 may be a disaggregated network node (sometimes referred to as a disaggregated base station), meaning that the network node 110 is configured to utilize a protocol stack that is physically or logically distributed among two or more nodes (such as one or more central units (CUs), one or more distributed units (DUs), or one or more radio units (RUs)).

In some examples, a network node 110 is or includes a network node that communicates with UEs 120 via a radio access link, such as an RU. In some examples, a network node 110 is or includes a network node that communicates with other network nodes 110 via a fronthaul link or a midhaul link, such as a DU. In some examples, a network node 110 is or includes a network node that communicates with other network nodes 110 via a midhaul link or a core network via a backhaul link, such as a CU. In some examples, a network node 110 (such as an aggregated network node 110 or a disaggregated network node 110) may include multiple network nodes, such as one or more RUs, one or more CUs, and/or one or more DUs. A network node 110 may include, for example, an NR base station, an LTE base station, a Node B, an eNB (e.g., in 4G), a gNB (e.g., in 5G), an access point, a transmission reception point (TRP), a DU, an RU, a CU, a mobility element of a network, a core network node, a network element, a network equipment, a RAN node, or a combination thereof. In some examples, the network nodes 110 may be interconnected to one another or to one or more other network nodes 110 in the wireless network 100 through various types of fronthaul, midhaul, and/or backhaul interfaces, such as a direct physical connection, an air interface, or a virtual network, using any suitable transport network.

In some examples, a network node 110 may provide communication coverage for a particular geographic area. In the Third Generation Partnership Project (3GPP), the term “cell” can refer to a coverage area of a network node 110 and/or a network node subsystem serving this coverage area, depending on the context in which the term is used. A network node 110 may provide communication coverage for a macro cell, a pico cell, a femto cell, and/or another type of cell. A macro cell may cover a relatively large geographic area (e.g., several kilometers in radius) and may allow unrestricted access by UEs 120 with service subscriptions. A pico cell may cover a relatively small geographic area and may allow unrestricted access by UEs 120 with service subscriptions. A femto cell may cover a relatively small geographic area (e.g., a home) and may allow restricted access by UEs 120 having association with the femto cell (e.g., UEs 120 in a closed subscriber group (CSG)). A network node 110 for a macro cell may be referred to as a macro network node. A network node 110 for a pico cell may be referred to as a pico network node. A network node 110 for a femto cell may be referred to as a femto network node or an in-home network node. In the example shown in FIG. 1, the network node 110a may be a macro network node for a macro cell 102a, the network node 110b may be a pico network node for a pico cell 102b, and the network node 110c may be a femto network node for a femto cell 102c. A network node may support one or multiple (e.g., three) cells. In some examples, a cell may not necessarily be stationary, and the geographic area of the cell may move according to the location of a network node 110 that is mobile (e.g., a mobile network node).

In some aspects, the terms “base station” or “network node” may refer to an aggregated base station, a disaggregated base station, an integrated access and backhaul (IAB) node, a relay node, or one or more components thereof. For example, in some aspects, “base station” or “network node” may refer to a CU, a DU, an RU, a Near-Real Time (Near-RT) RAN Intelligent Controller (RIC), or a Non-Real Time (Non-RT) RIC, or a combination thereof. In some aspects, the terms “base station” or “network node” may refer to one device configured to perform one or more functions, such as those described herein in connection with the network node 110. In some aspects, the terms “base station” or “network node” may refer to a plurality of devices configured to perform the one or more functions. For example, in some distributed systems, each of a quantity of different devices (which may be located in the same geographic location or in different geographic locations) may be configured to perform at least a portion of a function, or to duplicate performance of at least a portion of the function, and the terms “base station” or “network node” may refer to any one or more of those different devices. In some aspects, the terms “base station” or “network node” may refer to one or more virtual base stations or one or more virtual base station functions. For example, in some aspects, two or more base station functions may be instantiated on a single device. In some aspects, the terms “base station” or “network node” may refer to one of the base station functions and not another. In this way, a single device may include more than one base station.

The wireless network 100 may include one or more relay stations. A relay station is a network node that can receive a transmission of data from an upstream node (e.g., a network node 110 or a UE 120) and send a transmission of the data to a downstream node (e.g., a UE 120 or a network node 110). A relay station may be a UE 120 that can relay transmissions for other UEs 120. In the example shown in FIG. 1, the network node 110d (e.g., a relay network node) may communicate with the network node 110a (e.g., a macro network node) and the UE 120d in order to facilitate communication between the network node 110a and the UE 120d. A network node 110 that relays communications may be referred to as a relay station, a relay base station, a relay network node, a relay node, a relay, or the like.

The wireless network 100 may be a heterogeneous network that includes network nodes 110 of different types, such as macro network nodes, pico network nodes, femto network nodes, relay network nodes, or the like. These different types of network nodes 110 may have different transmit power levels, different coverage areas, and/or different impacts on interference in the wireless network 100. For example, macro network nodes may have a high transmit power level (e.g., 5 to 40 watts) whereas pico network nodes, femto network nodes, and relay network nodes may have lower transmit power levels (e.g., 0.1 to 2 watts).

A network controller 130 may couple to or communicate with a set of network nodes 110 and may provide coordination and control for these network nodes 110. The network controller 130 may communicate with the network nodes 110 via a backhaul communication link or a midhaul communication link. The network nodes 110 may communicate with one another directly or indirectly via a wireless or wireline backhaul communication link. In some aspects, the network controller 130 may be a CU or a core network device, or may include a CU or a core network device.

The UEs 120 may be dispersed throughout the wireless network 100, and each UE 120 may be stationary or mobile. A UE 120 may include, for example, an access terminal, a terminal, a mobile station, and/or a subscriber unit. A UE 120 may be a cellular phone (e.g., a smart phone), a personal digital assistant (PDA), a wireless modem, a wireless communication device, a handheld device, a laptop computer, a cordless phone, a wireless local loop (WLL) station, a tablet, a camera, a gaming device, a netbook, a smartbook, an ultrabook, a medical device, a biometric device, a wearable device (e.g., a smart watch, smart clothing, smart glasses, a smart wristband, smart jewelry (e.g., a smart ring or a smart bracelet)), an entertainment device (e.g., a music device, a video device, and/or a satellite radio), a vehicular component or sensor, a smart meter/sensor, industrial manufacturing equipment, a global positioning system device, a UE function of a network node, and/or any other suitable device that is configured to communicate via a wireless or wired medium.

Some UEs 120 may be considered machine-type communication (MTC) or evolved or enhanced machine-type communication (eMTC) UEs. An MTC UE and/or an eMTC UE may include, for example, a robot, a drone, a remote device, a sensor, a meter, a monitor, and/or a location tag, that may communicate with a network node, another device (e.g., a remote device), or some other entity. Some UEs 120 may be considered Internet-of-Things (IOT) devices, and/or may be implemented as NB-IOT (narrowband IoT) devices. Some UEs 120 may be considered a Customer Premises Equipment. A UE 120 may be included inside a housing that houses components of the UE 120, such as processor components and/or memory components. In some examples, the processor components and the memory components may be coupled together. For example, the processor components (e.g., one or more processors) and the memory components (e.g., a memory) may be operatively coupled, communicatively coupled, electronically coupled, and/or electrically coupled.

In general, any number of wireless networks 100 may be deployed in a given geographic area. Each wireless network 100 may support a particular RAT and may operate on one or more frequencies. A RAT may be referred to as a radio technology, an air interface, or the like. A frequency may be referred to as a carrier, a frequency channel, or the like. Each frequency may support a single RAT in a given geographic area in order to avoid interference between wireless networks of different RATs. In some cases, NR or 5G RAT networks may be deployed.

In some examples, two or more UEs 120 (e.g., shown as UE 120a and UE 120e) may communicate directly using one or more sidelink channels (e.g., without using a network node 110 as an intermediary to communicate with one another). For example, the UEs 120 may communicate using peer-to-peer (P2P) communications, device-to-device (D2D) communications, a vehicle-to-everything (V2X) protocol (e.g., which may include a vehicle-to-vehicle (V2V) protocol, a vehicle-to-infrastructure (V2I) protocol, or a vehicle-to-pedestrian (V2P) protocol), and/or a mesh network. In such examples, a UE 120 may perform scheduling operations, resource selection operations, and/or other operations described elsewhere herein as being performed by the network node 110.

Devices of the wireless network 100 may communicate using the electromagnetic spectrum, which may be subdivided by frequency or wavelength into various classes, bands, channels, or the like. For example, devices of the wireless network 100 may communicate using one or more operating bands. In 5G NR, two initial operating bands have been identified as frequency range designations FR1 (410 MHz-7.125 GHZ) and FR2 (24.25 GHz-52.6 GHZ). It should be understood that although a portion of FR1 is greater than 6 GHz, FR1 is often referred to (interchangeably) as a “Sub-6 GHz” band in various documents and articles. A similar nomenclature issue sometimes occurs with regard to FR2, which is often referred to (interchangeably) as a “millimeter wave” band in documents and articles, despite being different from the extremely high frequency (EHF) band (30 GHz-300 GHz) which is identified by the International Telecommunications Union (ITU) as a “millimeter wave” band.

The frequencies between FR1 and FR2 are often referred to as mid-band frequencies. Recent 5G NR studies have identified an operating band for these mid-band frequencies as frequency range designation FR3 (7.125 GHz-24.25 GHz). Frequency bands falling within FR3 may inherit FR1 characteristics and/or FR2 characteristics, and thus may effectively extend features of FR1 and/or FR2 into mid-band frequencies. In addition, higher frequency bands are currently being explored to extend 5G NR operation beyond 52.6 GHz. For example, three higher operating bands have been identified as frequency range designations FR4a or FR4-1 (52.6 GHZ-71 GHz), FR4 (52.6 GHz-114.25 GHz), and FR5 (114.25 GHz-300 GHz). Each of these higher frequency bands falls within the EHF band.

With the above examples in mind, unless specifically stated otherwise, it should be understood that the term “sub-6 GHZ” or the like, if used herein, may broadly represent frequencies that may be less than 6 GHZ, may be within FR1, or may include mid-band frequencies. Further, unless specifically stated otherwise, it should be understood that the term “millimeter wave” or the like, if used herein, may broadly represent frequencies that may include mid-band frequencies, may be within FR2, FR4, FR4-a or FR4-1, and/or FR5, or may be within the EHF band. It is contemplated that the frequencies included in these operating bands (e.g., FR1, FR2, FR3, FR4, FR4-a, FR4-1, and/or FR5) may be modified, and techniques described herein are applicable to those modified frequency ranges.

In some aspects, a UE (e.g., the UE 120) may include a communication manager 140. As described in more detail elsewhere herein, the communication manager 140 may transmit or receive one or more of: a UE capability report, a condition triggered functionality validation request, a network confirmation of a functionality validation, or a network rejection of the functionality validation, based at least in part on a functionality associated with a UE-side AI/ML operation; and perform an action based at least in part on whether the functionality associated with the UE-side AI/ML operation is validated or invalidated in accordance with one or more of: the UE capability report, the condition triggered functionality validation request, the network confirmation of the functionality validation, or the network rejection of the functionality validation. Additionally, or alternatively, the communication manager 140 may perform one or more other operations described herein.

In some aspects, a network node (e.g., the network node 110) may include a communication manager 150. As described in more detail elsewhere herein, the communication manager 150 may transmit or receive one or more of: a UE capability report, a condition triggered functionality validation request, a network confirmation of a functionality validation, or a network rejection of the functionality validation, based at least in part on a functionality associated with a UE-side AI/ML operation, and the functionality being validated or invalidated in accordance with one or more of: the UE capability report, the condition triggered functionality validation request, the network confirmation of the functionality validation, or the network rejection of the functionality validation. Additionally, or alternatively, the communication manager 150 may perform one or more other operations described herein.

As indicated above, FIG. 1 is provided as an example. Other examples may differ from what is described with regard to FIG. 1.

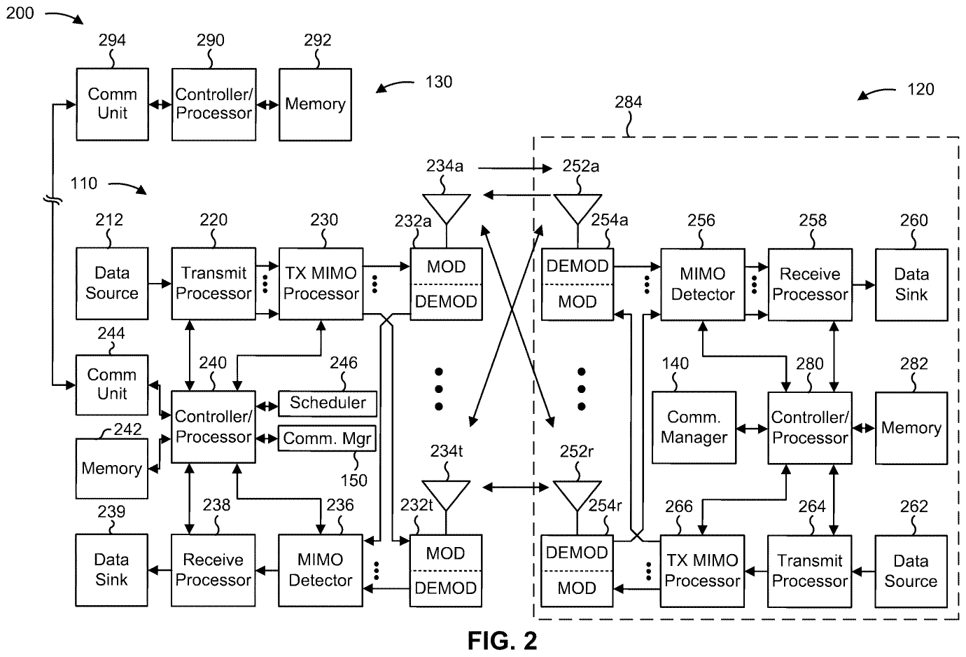

FIG. 2 is a diagram illustrating an example 200 of a network node 110 in communication with a UE 120 in a wireless network 100, in accordance with the present disclosure. The network node 110 may be equipped with a set of antennas 234a through 234t, such as T antennas (T≥1). The UE 120 may be equipped with a set of antennas 252a through 252r, such as R antennas (R≥1). The network node 110 of example 200 includes one or more radio frequency components, such as antennas 234 and a modem 232. In some examples, a network node 110 may include an interface, a communication component, or another component that facilitates communication with the UE 120 or another network node. Some network nodes 110 may not include radio frequency components that facilitate direct communication with the UE 120, such as one or more CUs, or one or more DUs.

At the network node 110, a transmit processor 220 may receive data, from a data source 212, intended for the UE 120 (or a set of UEs 120). The transmit processor 220 may select one or more modulation and coding schemes (MCSs) for the UE 120 based at least in part on one or more channel quality indicators (CQIs) received from that UE 120. The network node 110 may process (e.g., encode and modulate) the data for the UE 120 based at least in part on the MCS(s) selected for the UE 120 and may provide data symbols for the UE 120. The transmit processor 220 may process system information (e.g., for semi-static resource partitioning information (SRPI)) and control information (e.g., CQI requests, grants, and/or upper layer signaling) and provide overhead symbols and control symbols. The transmit processor 220 may generate reference symbols for reference signals (e.g., a cell-specific reference signal (CRS) or a demodulation reference signal (DMRS)) and synchronization signals (e.g., a primary synchronization signal (PSS) or a secondary synchronization signal (SSS)). A transmit (TX) multiple-input multiple-output (MIMO) processor 230 may perform spatial processing (e.g., precoding) on the data symbols, the control symbols, the overhead symbols, and/or the reference symbols, if applicable, and may provide a set of output symbol streams (e.g., T output symbol streams) to a corresponding set of modems 232 (e.g., T modems), shown as modems 232a through 232t. For example, each output symbol stream may be provided to a modulator component (shown as MOD) of a modem 232. Each modem 232 may use a respective modulator component to process a respective output symbol stream (e.g., for OFDM) to obtain an output sample stream. Each modem 232 may further use a respective modulator component to process (e.g., convert to analog, amplify, filter, and/or upconvert) the output sample stream to obtain a downlink signal. The modems 232a through 232t may transmit a set of downlink signals (e.g., T downlink signals) via a corresponding set of antennas 234 (e.g., T antennas), shown as antennas 234a through 234t.

At the UE 120, a set of antennas 252 (shown as antennas 252a through 252r) may receive the downlink signals from the network node 110 and/or other network nodes 110 and may provide a set of received signals (e.g., R received signals) to a set of modems 254 (e.g., R modems), shown as modems 254a through 254r. For example, each received signal may be provided to a demodulator component (shown as DEMOD) of a modem 254. Each modem 254 may use a respective demodulator component to condition (e.g., filter, amplify, downconvert, and/or digitize) a received signal to obtain input samples. Each modem 254 may use a demodulator component to further process the input samples (e.g., for OFDM) to obtain received symbols. A MIMO detector 256 may obtain received symbols from the modems 254, may perform MIMO detection on the received symbols if applicable, and may provide detected symbols. A receive processor 258 may process (e.g., demodulate and decode) the detected symbols, may provide decoded data for the UE 120 to a data sink 260, and may provide decoded control information and system information to a controller/processor 280. The term “controller/processor” may refer to one or more controllers, one or more processors, or a combination thereof. A channel processor may determine a reference signal received power (RSRP) parameter, a received signal strength indicator (RSSI) parameter, a reference signal received quality (RSRQ) parameter, and/or a CQI parameter, among other examples. In some examples, one or more components of the UE 120 may be included in a housing 284.

The network controller 130 may include a communication unit 294, a controller/processor 290, and a memory 292. The network controller 130 may include, for example, one or more devices in a core network. The network controller 130 may communicate with the network node 110 via the communication unit 294.

One or more antennas (e.g., antennas 234a through 234t and/or antennas 252a through 252r) may include, or may be included within, one or more antenna panels, one or more antenna groups, one or more sets of antenna elements, and/or one or more antenna arrays, among other examples. An antenna panel, an antenna group, a set of antenna elements, and/or an antenna array may include one or more antenna elements (within a single housing or multiple housings), a set of coplanar antenna elements, a set of non-coplanar antenna elements, and/or one or more antenna elements coupled to one or more transmission and/or reception components, such as one or more components of FIG. 2.

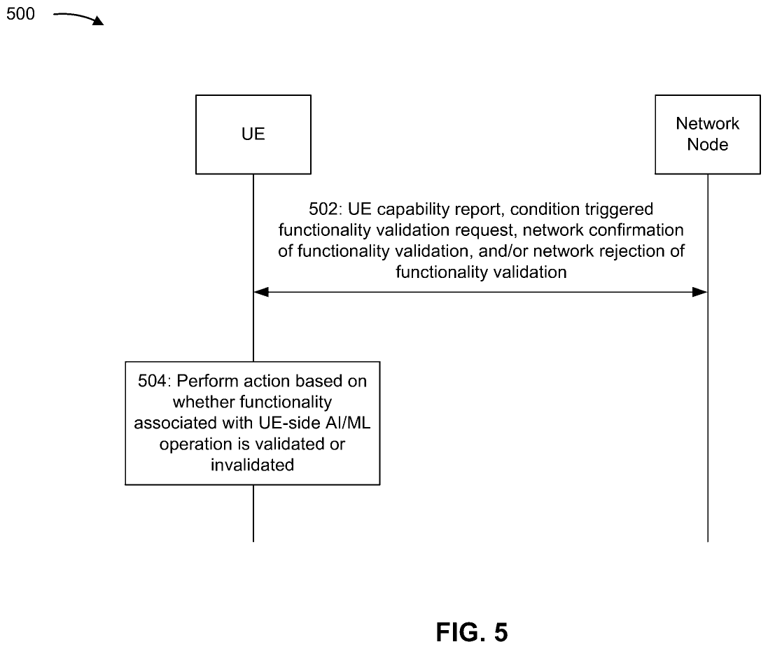

On the uplink, at the UE 120, a transmit processor 264 may receive and process data from a data source 262 and control information (e.g., for reports that include RSRP, RSSI, RSRQ, and/or CQI) from the controller/processor 280. The transmit processor 264 may generate reference symbols for one or more reference signals. The symbols from the transmit processor 264 may be precoded by a TX MIMO processor 266 if applicable, further processed by the modems 254 (e.g., for DFT-s-OFDM or CP-OFDM), and transmitted to the network node 110. In some examples, the modem 254 of the UE 120 may include a modulator and a demodulator. In some examples, the UE 120 includes a transceiver. The transceiver may include any combination of the antenna(s) 252, the modem(s) 254, the MIMO detector 256, the receive processor 258, the transmit processor 264, and/or the TX MIMO processor 266. The transceiver may be used by a processor (e.g., the controller/processor 280) and the memory 282 to perform aspects of any of the methods described herein (e.g., with reference to FIGS. 5-9).

At the network node 110, the uplink signals from UE 120 and/or other UEs may be received by the antennas 234, processed by the modem 232 (e.g., a demodulator component, shown as DEMOD, of the modem 232), detected by a MIMO detector 236 if applicable, and further processed by a receive processor 238 to obtain decoded data and control information sent by the UE 120. The receive processor 238 may provide the decoded data to a data sink 239 and provide the decoded control information to the controller/processor 240. The network node 110 may include a communication unit 244 and may communicate with the network controller 130 via the communication unit 244. The network node 110 may include a scheduler 246 to schedule one or more UEs 120 for downlink and/or uplink communications. In some examples, the modem 232 of the network node 110 may include a modulator and a demodulator. In some examples, the network node 110 includes a transceiver. The transceiver may include any combination of the antenna(s) 234, the modem(s) 232, the MIMO detector 236, the receive processor 238, the transmit processor 220, and/or the TX MIMO processor 230. The transceiver may be used by a processor (e.g., the controller/processor 240) and the memory 242 to perform aspects of any of the methods described herein (e.g., with reference to FIGS. 5-9).

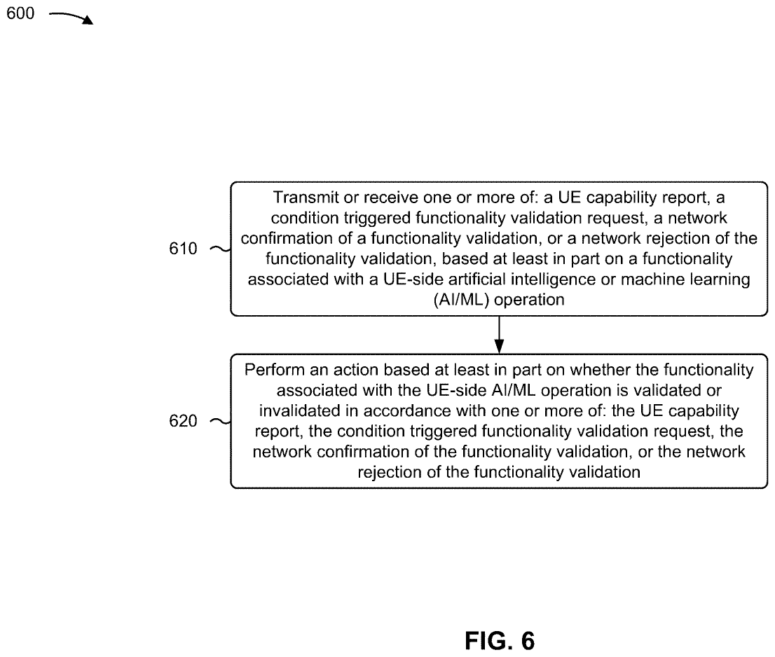

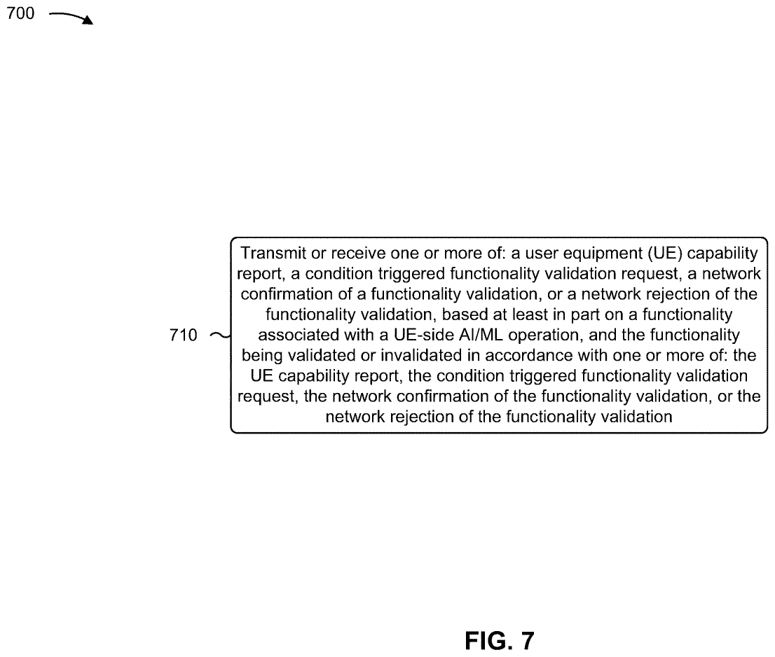

The controller/processor 240 of the network node 110, the controller/processor 280 of the UE 120, and/or any other component(s) of FIG. 2 may perform one or more techniques associated with validation of functionalities associated with UE-side operations, as described in more detail elsewhere herein. For example, the controller/processor 240 of the network node 110, the controller/processor 280 of the UE 120, and/or any other component(s) of FIG. 2 may perform or direct operations of, for example, process 600 of FIG. 6, process 700 of FIG. 7, and/or other processes as described herein. The memory 242 and the memory 282 may store data and program codes for the network node 110 and the UE 120, respectively. In some examples, the memory 242 and/or the memory 282 may include a non-transitory computer-readable medium storing one or more instructions (e.g., code and/or program code) for wireless communication. For example, the one or more instructions, when executed (e.g., directly, or after compiling, converting, and/or interpreting) by one or more processors of the network node 110 and/or the UE 120, may cause the one or more processors, the UE 120, and/or the network node 110 to perform or direct operations of, for example, process 600 of FIG. 6, process 700 of FIG. 7, and/or other processes as described herein. In some examples, executing instructions may include running the instructions, converting the instructions, compiling the instructions, and/or interpreting the instructions, among other examples.

In some aspects, a UE (e.g., the UE 120) includes means for transmitting or receiving one or more of: a UE capability report, a condition triggered functionality validation request, a network confirmation of a functionality validation, or a network rejection of the functionality validation, based at least in part on a functionality associated with a UE-side AI/ML operation; and/or means for performing an action based at least in part on whether the functionality associated with the UE-side AI/ML operation is validated or invalidated in accordance with one or more of: the UE capability report, the condition triggered functionality validation request, the network confirmation of the functionality validation, or the network rejection of the functionality validation. The means for the UE to perform operations described herein may include, for example, one or more of communication manager 140, antenna 252, modem 254, MIMO detector 256, receive processor 258, transmit processor 264, TX MIMO processor 266, controller/processor 280, or memory 282.

In some aspects, a network node (e.g., the network node 110) includes means for transmitting or receiving one or more of: a UE capability report, a condition triggered functionality validation request, a network confirmation of a functionality validation, or a network rejection of the functionality validation, based at least in part on a functionality associated with a UE-side AI/ML operation, and the functionality being validated or invalidated in accordance with one or more of: the UE capability report, the condition triggered functionality validation request, the network confirmation of the functionality validation, or the network rejection of the functionality validation. The means for the network node to perform operations described herein may include, for example, one or more of communication manager 150, transmit processor 220, TX MIMO processor 230, modem 232, antenna 234, MIMO detector 236, receive processor 238, controller/processor 240, memory 242, or scheduler 246.

While blocks in FIG. 2 are illustrated as distinct components, the functions described above with respect to the blocks may be implemented in a single hardware, software, or combination component or in various combinations of components. For example, the functions described with respect to the transmit processor 264, the receive processor 258, and/or the TX MIMO processor 266 may be performed by or under the control of the controller/processor 280.

As indicated above, FIG. 2 is provided as an example. Other examples may differ from what is described with regard to FIG. 2.

Deployment of communication systems, such as 5G NR systems, may be arranged in multiple manners with various components or constituent parts. In a 5G NR system, or network, a network node, a network entity, a mobility element of a network, a RAN node, a core network node, a network element, a base station, or a network equipment may be implemented in an aggregated or disaggregated architecture. For example, a base station (such as a Node B (NB), an evolved NB (eNB), an NR base station, a 5G NB, an access point (AP), a TRP, or a cell, among other examples), or one or more units (or one or more components) performing base station functionality, may be implemented as an aggregated base station (also known as a standalone base station or a monolithic base station) or a disaggregated base station. “Network entity” or “network node” may refer to a disaggregated base station, or to one or more units of a disaggregated base station (such as one or more CUs, one or more DUs, one or more RUs, or a combination thereof).

An aggregated base station (e.g., an aggregated network node) may be configured to utilize a radio protocol stack that is physically or logically integrated within a single RAN node (e.g., within a single device or unit). A disaggregated base station (e.g., a disaggregated network node) may be configured to utilize a protocol stack that is physically or logically distributed among two or more units (such as one or more CUs, one or more DUs, or one or more RUs). In some examples, a CU may be implemented within a network node, and one or more DUs may be co-located with the CU, or alternatively, may be geographically or virtually distributed throughout one or multiple other network nodes. The DUs may be implemented to communicate with one or more RUs. Each of the CU, DU, and RU also can be implemented as virtual units, such as a virtual central unit (VCU), a virtual distributed unit (VDU), or a virtual radio unit (VRU), among other examples.

Base station-type operation or network design may consider aggregation characteristics of base station functionality. For example, disaggregated base stations may be utilized in an IAB network, an open radio access network (O-RAN (such as the network configuration sponsored by the O-RAN Alliance)), or a virtualized radio access network (vRAN, also known as a cloud radio access network (C-RAN)) to facilitate scaling of communication systems by separating base station functionality into one or more units that can be individually deployed. A disaggregated base station may include functionality implemented across two or more units at various physical locations, as well as functionality implemented for at least one unit virtually, which can enable flexibility in network design. The various units of the disaggregated base station can be configured for wired or wireless communication with at least one other unit of the disaggregated base station.

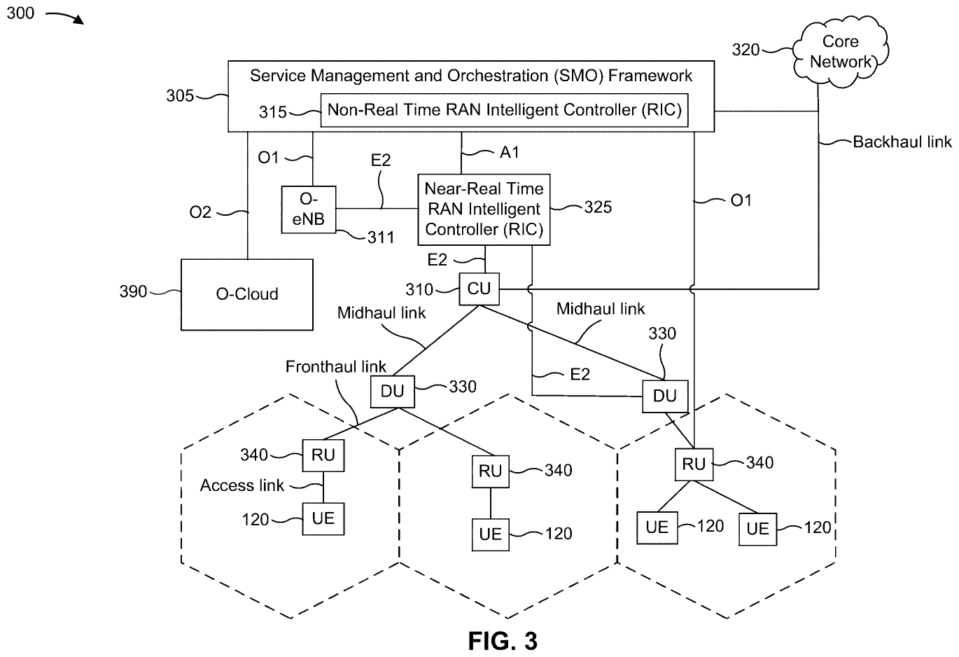

FIG. 3 is a diagram illustrating an example disaggregated base station architecture 300, in accordance with the present disclosure. The disaggregated base station architecture 300 may include a CU 310 that can communicate directly with a core network 320 via a backhaul link, or indirectly with the core network 320 through one or more disaggregated control units (such as a Near-RT RIC 325 via an E2 link, or a Non-RT RIC 315 associated with a Service Management and Orchestration (SMO) Framework 305, or both). A CU 310 may communicate with one or more DUs 330 via respective midhaul links, such as through F1 interfaces. Each of the DUs 330 may communicate with one or more RUs 340 via respective fronthaul links. Each of the RUs 340 may communicate with one or more UEs 120 via respective radio frequency (RF) access links. In some implementations, a UE 120 may be simultaneously served by multiple RUs 340.

Each of the units, including the CUS 310, the DUs 330, the RUs 340, as well as the Near-RT RICs 325, the Non-RT RICs 315, and the SMO Framework 305, may include one or more interfaces or be coupled with one or more interfaces configured to receive or transmit signals, data, or information (collectively, signals) via a wired or wireless transmission medium. Each of the units, or an associated processor or controller providing instructions to one or multiple communication interfaces of the respective unit, can be configured to communicate with one or more of the other units via the transmission medium. In some examples, each of the units can include a wired interface, configured to receive or transmit signals over a wired transmission medium to one or more of the other units, and a wireless interface, which may include a receiver, a transmitter or transceiver (such as an RF transceiver), configured to receive or transmit signals, or both, over a wireless transmission medium to one or more of the other units.

In some aspects, the CU 310 may host one or more higher layer control functions. Such control functions can include radio resource control (RRC) functions, packet data convergence protocol (PDCP) functions, or service data adaptation protocol (SDAP) functions, among other examples. Each control function can be implemented with an interface configured to communicate signals with other control functions hosted by the CU 310. The CU 310 may be configured to handle user plane functionality (for example, Central Unit-User Plane (CU-UP) functionality), control plane functionality (for example, Central Unit-Control Plane (CU-CP) functionality), or a combination thereof. In some implementations, the CU 310 can be logically split into one or more CU-UP units and one or more CU-CP units. A CU-UP unit can communicate bidirectionally with a CU-CP unit via an interface, such as the El interface when implemented in an O-RAN configuration. The CU 310 can be implemented to communicate with a DU 330, as necessary, for network control and signaling.

Each DU 330 may correspond to a logical unit that includes one or more base station functions to control the operation of one or more RUs 340. In some aspects, the DU 330 may host one or more of a radio link control (RLC) layer, a medium access control (MAC) layer, and one or more high physical (PHY) layers depending, at least in part, on a functional split, such as a functional split defined by the 3GPP. In some aspects, the one or more high PHY layers may be implemented by one or more modules for forward error correction (FEC) encoding and decoding, scrambling, and modulation and demodulation, among other examples. In some aspects, the DU 330 may further host one or more low PHY layers, such as implemented by one or more modules for a fast Fourier transform (FFT), an inverse FFT (iFFT), digital beamforming, or physical random access channel (PRACH) extraction and filtering, among other examples. Each layer (which also may be referred to as a module) can be implemented with an interface configured to communicate signals with other layers (and modules) hosted by the DU 330, or with the control functions hosted by the CU 310.

Each RU 340 may implement lower-layer functionality. In some deployments, an RU 340, controlled by a DU 330, may correspond to a logical node that hosts RF processing functions or low-PHY layer functions, such as performing an FFT, performing an iFFT, digital beamforming, or PRACH extraction and filtering, among other examples, based on a functional split (for example, a functional split defined by the 3GPP), such as a lower layer functional split. In such an architecture, each RU 340 can be operated to handle over the air (OTA) communication with one or more UEs 120. In some implementations, real-time and non-real-time aspects of control and user plane communication with the RU(s) 340 can be controlled by the corresponding DU 330. In some scenarios, this configuration can enable each DU 330 and the CU 310 to be implemented in a cloud-based RAN architecture, such as a vRAN architecture.

The SMO Framework 305 may be configured to support RAN deployment and provisioning of non-virtualized and virtualized network elements. For non-virtualized network elements, the SMO Framework 305 may be configured to support the deployment of dedicated physical resources for RAN coverage requirements, which may be managed via an operations and maintenance interface (such as an O1 interface). For virtualized network elements, the SMO Framework 305 may be configured to interact with a cloud computing platform (such as an open cloud (O-Cloud) platform 390) to perform network element life cycle management (such as to instantiate virtualized network elements) via a cloud computing platform interface (such as an O2 interface). Such virtualized network elements can include, but are not limited to, CUs 310, DUs 330, RUs 340, non-RT RICs 315, and Near-RT RICs 325. In some implementations, the SMO Framework 305 can communicate with a hardware aspect of a 4G RAN, such as an open eNB (O-eNB) 311, via an O1 interface. Additionally, in some implementations, the SMO Framework 305 can communicate directly with each of one or more RUs 340 via a respective O1 interface. The SMO Framework 305 also may include a Non-RT RIC 315 configured to support functionality of the SMO Framework 305.

The Non-RT RIC 315 may be configured to include a logical function that enables non-real-time control and optimization of RAN elements and resources, AI/ML workflows including model training and updates, or policy-based guidance of applications/features in the Near-RT RIC 325. The Non-RT RIC 315 may be coupled to or communicate with (such as via an Al interface) the Near-RT RIC 325. The Near-RT RIC 325 may be configured to include a logical function that enables near-real-time control and optimization of RAN elements and resources via data collection and actions over an interface (such as via an E2 interface) connecting one or more CUs 310, one or more DUs 330, or both, as well as an O-eNB, with the Near-RT RIC 325.

In some implementations, to generate AI/ML models to be deployed in the Near-RT RIC 325, the Non-RT RIC 315 may receive parameters or external enrichment information from external servers. Such information may be utilized by the Near-RT RIC 325 and may be received at the SMO Framework 305 or the Non-RT RIC 315 from non-network data sources or from network functions. In some examples, the Non-RT RIC 315 or the Near-RT RIC 325 may be configured to tune RAN behavior or performance. For example, the Non-RT RIC 315 may monitor long-term trends and patterns for performance and employ AI/ML models to perform corrective actions through the SMO Framework 305 (such as reconfiguration via an O1 interface) or via creation of RAN management policies (such as A1 interface policies).

As indicated above, FIG. 3 is provided as an example. Other examples may differ from what is described with regard to FIG. 3.

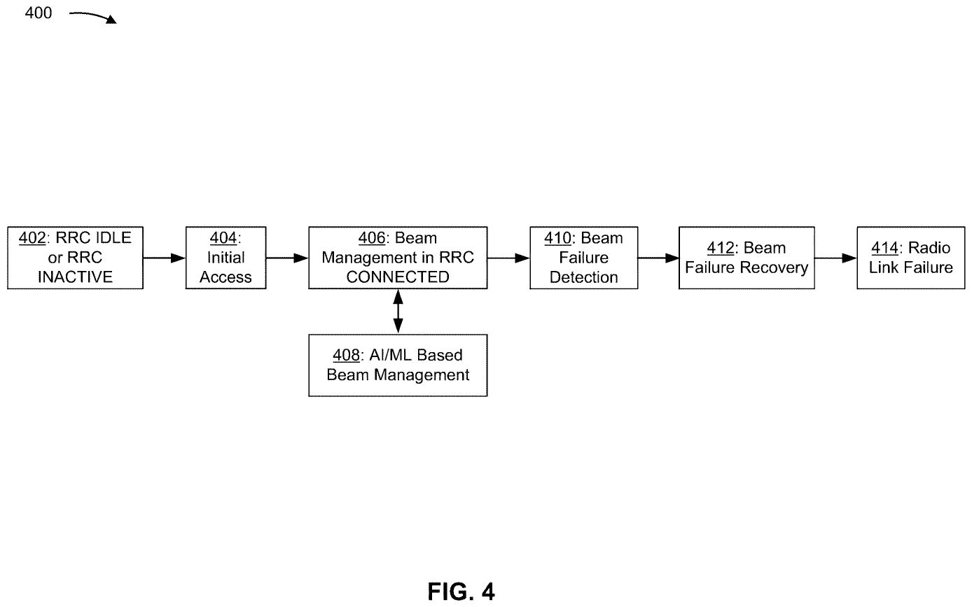

FIG. 4 is a diagram illustrating an example 400 of beam management, in accordance with the present disclosure.

As shown by reference number 402, a UE may initially be in an RRC idle state or an RRC inactive state. As shown by reference number 404, the UE may perform an initial access. As shown by reference number 406, the UE may perform a beam management after entering an RRC connected state. The beam management may include P1, P2, and/or P3 beam management procedures. The P1 beam management procedure may be a beam selection procedure, an initial beam acquisition procedure, a beam sweeping procedure, a cell search procedure, and/or a beam search procedure. The P2 beam management procedure may be a beam refinement procedure, a network node beam refinement procedure, a TRP beam refinement procedure, and/or a transmit (Tx) beam refinement procedure. The P3 beam management procedure may be a beam refinement procedure, a UE beam refinement procedure, and/or an Rx beam refinement procedure. As shown by reference number 408, the UE may also perform beam management using an AI/ML-based approach. The beam management using the AI/ML-based approach may use an AI/ML model in a spatial domain (SD), a time domain (TD), and/or a frequency domain (FD), which may reduce signaling overhead and latency and improve a beam selection accuracy. The AI/ML model may be associated with a lifecycle management, which may involve a model training, model deployment, model inference, model monitoring, and/or model updating. As shown by reference number 410, the UE may perform a beam failure detection (BFD), which may be based at least in part on measurements obtained during the beam management after entering the RRC connected mode. As shown by reference number 412, the UE may perform a beam failure recovery (BFR) based at least in part on the BFD. As shown by reference number 414, when the BFR is not successful, the UE may declare a radio link failure (RLF).

As indicated above, FIG. 4 is provided as an example. Other examples may differ from what is described with regard to FIG. 4.

For an AI/ML-based beam management, a first beam management case and a second beam management case may be supported for characterization and baseline performance evaluations. The first beam management case may involve a spatial domain downlink beam prediction for a first set of beams (Set A) based at least in part on measurement results of a second set of beams (Set B). The second beam management case may involve a temporal downlink beam prediction for the first set of beams based at least in part on historical measurement results of the second set of beams. For the first beam management case and the second beam management case, beams in the first set of beams and beams in the second set of beams may be in the same frequency range.

In the first beam management case, in a first alternative, the second set of beams may be a subset of the first set of beams. In the first alternative, the first set of beams and the second set of beams may each be associated with a defined quantity of beams. The second set of beams may be determined from beams in the first set of beams based at least in part on a fixed pattern or a random pattern. In a second alternative, the first set of beams may be different from the second set of beams (e.g., the first set of beams may include narrow beams and the second set of beams may include wide beams). In the second alternative, the first set of beams and the second set of beams may each be associated with a defined quantity of beams. A quasi co-location (QCL) relation may be defined between beams in the first set of beams and beams in the second set of beams. Further, the first set of beams may be for downlink beam prediction, and the second set of beams may be for downlink beam measurement.

For the first beam management case and with a UE-side AI/ML model, layer 1 (L1) signaling may be used to report information associated with an AI/ML model inference to a network node. The information may indicate one or more beams (e.g., reported beams) that are based at least in part on an output of the AI/ML model inference. The information may indicate predicted L1-RSRP measurements corresponding to the one or more beams.

For the second beam management case and with the UE-side AI/ML model, L1 signaling may be used to report information associated with the AI/ML model inference to the network node. The information may indicate one or more beams of N upcoming time instances, where the one or more beams may be based at least in part on the output of the AI/ML model inference. A value for N may be defined. The information may indicate predicted L1-RSRP measurements corresponding to the one or more beams. The information may indicate a timestamp corresponding to the one or more beams, where the timestamp may be indicated explicitly or implicitly.

For the first and second beam management cases with the UE-side AI/ML model, a model monitoring may be employed. For a UE-side model monitoring, the UE may monitor performance metrics. The UE may perform decisions of model selection, activation, deactivation, switching, or fallback operation based at least in part on the performance metrics. For a network-side model monitoring, the network node may monitor performance metrics. The network node may perform decisions of model selection, activation, deactivation, switching, or fallback operation based at least in part on the performance metrics. In a hybrid model monitoring, the UE may monitor performance metrics, and the network node may perform decisions of model selection, activation, deactivation, switching, or fallback operation based at least in part on the performance metrics.

For the first and second beam management cases with a network-side AI/ML model, the network-side model monitoring may be employed. The network node may monitor the performance metrics, and the network node may perform decisions of model selection, activation, deactivation, switching, or fallback operation based at least in part on the performance metrics. For the first and second beam management cases with the network-side AI/ML model, a beam measurement and report for model monitoring may be employed. For the first and second beam management cases with the network-side AI/ML model, the UE may report measurement results of more than four beams in one reporting instance based at least in part on an L1 beam reporting for the AI/ML model inference.

A functionality-based implicit ML inference parameter group switch may be defined. A standard may predefine a quantity of functionalities for AI/ML-based UE operation. Each functionality (e.g., beam prediction, CSF, and positioning) may include a quantity of sub-functionalities (e.g., time domain beam prediction, spatial domain beam prediction, and frequency domain beam prediction). Standard predefined functionalities may include the time domain beam prediction, the spatial domain beam prediction, the frequency domain beam prediction, an AI/ML-based CSI feedback, and/or an AI/ML-based positioning. Each sub-functionality may include sub-sub-functionalities (e.g., predicting 8 future occasions with 4 historical measurements, predicting 8 future occasions with 8 historical measurements, or predicting 8 future occasions with 16 historical measurements). Parameters including specific UE behaviors, an expected AI/ML input/output, or an expected network node assistance information or reference signal, for a certain predefined functionality (or sub-functionality), may be predefined.

A UE may receive network node indications requesting the UE to be switched to one or more standard predefined functionalities (or sub-functionalities), such that parameters associated with the requested functionalities may also be implicitly switched without further signaling. The network node may transmit, to the UE, a command for switching to a particular functionality (or sub-functionality). The command may trigger a variation of a parameter group without the further signaling. The parameters may be associated with a certain CSI report setting for reporting prediction results.

In past approaches, AI/ML functionalities are validated (or activated) all of the time. The AI/ML functionalities may include a beam prediction, CSF, and/or positioning. The AI/ML functionalities may be for an AI/ML based UE operation. The UE may constantly validate (or activate) the AI/ML functionalities, even when such AI/ML functionalities are not needed, which may waste resources (e.g., power, bandwidth, and/or processing) associated with the UE.

In various aspects of techniques and apparatuses described herein, a UE may transmit or receive, to or from a network node, respectively, a UE capability report, a condition triggered functionality validation request, a network confirmation of a functionality validation, and/or a network rejection of the functionality validation, based at least in part on a functionality associated with a UE-side AI/ML operation. The functionality associated with the UE-side AI/ML operation may be a time domain beam prediction, a spatial domain beam prediction, a frequency domain beam prediction, an AI/ML based CSI feedback, or an AI/ML based positioning. The UE may perform an action based at least in part on whether the functionality associated with the UE-side AI/ML operation is validated or invalidated in accordance with the UE capability report, the condition triggered functionality validation request, the network confirmation of the functionality validation, and/or the network rejection of the functionality validation. The UE, when performing the action, may perform the functionality based at least in part on the functionality being validated. Alternatively, the UE, when performing the action, may refrain from performing the functionality based at least in part on the functionality being invalidated. As a result, the UE may selectively validate or invalidate AI/ML functionalities, which may conserve resources associated with the UE, and thereby improve a performance associated with the UE.

In some aspects, the UE may be configured to selectively validate (or activate) AI/ML functionalities, depending on certain factors. The UE may employ a validation of functionalities for UE based beam prediction via AI/ML.

In some aspects, whether a certain functionality should be considered to be validated (or activated) may depend on UE capabilities. For example, certain UEs may only support pure spatial beam prediction but may not support spatial temporal beam prediction, while certain other UEs may support both. A UE may report such information to the network node as its capabilities during an initial access.

In some aspects, whether the certain functionality should be considered to be validated (or activated) may depend on conditions that potentially validate the AI/ML functionalities. For example, when L1-RSRP measurements associated with synchronization signal blocks (SSBs) satisfy a predefined threshold or a network node configured threshold (e.g., the L1-RSRP measurements are sufficiently high), and/or a time domain variation level of the L1-RSRP measurements satisfies a predefined threshold or a network node configured threshold (e.g., the time domain variation is sufficiently slow), the UE may prefer to perform a time domain L1-RSRP prediction. A preference for the time domain L1-RSRP prediction may be UE locally identified based at least in part on such thresholds as triggering conditions. The UE may also report the preference of validating (or activating) the time domain L1-RSRP prediction to the network node.

In some aspects, whether the certain functionality should be considered to be validated (or activated) may depend on a network node confirmation or rejection of an AI/ML functionality validation. The UE may need to wait for a final network node signaling to confirm an activation of the time domain L1-RSRP prediction. Alternatively, the network node may reject a UE request for various reasons (e.g., ultra-reliable low latency communications (URLLC) traffic from the UE). The UE may perform a preparation (e.g., identify a proper model and preload the model to its AI/ML hardware/software engine) after transmitting a validation request and before receiving the network node confirmation. A duration of time needed to receive the network node confirmation may depend on the validation request. In certain scenarios, the network node confirmation may not be needed or may be implicitly identified. For example, the network node scheduling the UE with a measured beam beyond an L1-RSRP threshold as its transmission configuration indicator (TCI) state may implicitly validate a time domain beam prediction functionality.

FIG. 5 is a diagram illustrating an example 500 associated with validation of functionalities associated with UE-side operations, in accordance with the present disclosure. As shown in FIG. 5, example 500 includes communication between a UE (e.g., UE 120) and a network node (e.g., network node 110). In some aspects, the UE and the network node may be included in a wireless network, such as wireless network 100.

As shown by reference number 502, the UE may transmit or receive, to or from the network node, respectively, a UE capability report, a condition triggered functionality validation request, a network confirmation of a functionality validation, and/or a network rejection of the functionality validation, based at least in part on a functionality associated with a UE-side AI/ML operation. The functionality associated with the UE-side AI/ML operation may be a time domain beam prediction, a spatial domain beam prediction, a frequency domain beam prediction, an AI/ML-based CSI feedback, and/or an AI/ML-based positioning.

In some aspects, the UE may transmit the UE capability report via RRC signaling during an initial access. The functionality may be validated based at least in part on the UE capability report indicating that the functionality is supported by the UE. In some aspects, the UE may transmit the condition triggered functionality validation request based at least in part on a condition being satisfied. The condition triggered functionality validation request may indicate a request to validate the functionality. The condition may be associated with a standard predefinition, a network configuration or indication, or a UE recommendation. The functionality may be validated based at least in part on the condition triggered functionality validation request. In some aspects, the UE may receive the network confirmation of the functionality validation, which may indicate that the request to validate the functionality is accepted and that the functionality is validated. In some aspects, the UE may receive the network rejection of the functionality validation, which may indicate that the request to validate the functionality is rejected and that the functionality is invalidated.

In some aspects, a validation of functionalities may be employed for a UE based prediction. The UE may identify whether the functionality associated with a UE-side AI/ML operation is validated (or activated) or invalidated (or deactivated). The functionality may be based at least in part on the time domain beam prediction, the spatial domain beam prediction, and/or the frequency domain beam prediction. The functionality may be based at least in part on an AI/ML based CSI feedback. The functionality may be based at least in part on an AI/ML based positioning.

In some aspects, the UE may identify whether the functionality associated with the UE-side AI/ML operation is validated (or activated) or invalidated (or deactivated) based at least in part on the UE capability report. The functionality may be associated with a certain number of UE capabilities reported via RRC signaling during an initial access. The validation of the functionality may be based at least in part on the UE capability reporting indicating that such capabilities are supported by the UE. The UE may also dynamically update such capabilities via a MAC control element (MAC-CE) or downlink control information (DCI).

In some aspects, the UE may identify whether the functionality associated with the UE-side AI/ML operation is validated (or activated) or invalidated (or deactivated) based at least in part on the condition triggered functionality validation request. Certain conditions may trigger the UE to send an explicit request to the network node on validating the functionality. The conditions may be associated with the functionality, which may be based at least in part on the standard predefinition, the network configuration/indication, and/or the UE recommendation. In some cases, an implicit functionality validation may be without the explicit validation request. The UE may consider that the validation request is already transmitted based at least in part on other types of UE feedbacks without introducing dedicated functionality validation request messages.

In some aspects, the UE may identify whether the functionality associated with the UE-side AI/ML operation is validated (or activated) or invalidated (or deactivated) based at least in part on the network node confirmation or rejection of functionality validation. The network node may transmit additional signaling (e.g., RRC signaling, a MAC-CE, or a DCI) as a confirmation, such that the functionality may be considered to be validated. Alternatively, the network node may indicate in such messages that a UE request on validating the functionality is rejected. In some cases, no additional network node signaling regarding the confirmation/rejection may be needed for an implicit validation request, such that the functionality may be considered to be validated based at least in part on only such UE implicit feedbacks.

In some aspects, the UE may determine a UE preparation time for validating the functionality based at least in part on a standard predefinition, a network configuration, and/or the UE capability report. The UE preparation time may start at a time associated with a condition with respect to the functionality being satisfied and and at a time associated with a receipt of the network confirmation of the functionality validation. The UE preparation time may start at a time associated with a transmission of the condition triggered functionality validation request and end at a time associated with a receipt of the network confirmation of the functionality validation. The UE preparation time may start at a time associated with a condition with respect to the functionality being satisfied and end at a time associated with the functionality being validated. The UE preparation time may start at a time associated with a transmission of a message indicating that a condition with respect to the functionality is satisfied, and end at a time associated with the functionality being validated.

In some aspects, a functionality validation may be based at least in part on a UE preparation timeline. The UE preparation time for validating (or activating) a certain functionality may be defined. In some aspects, the UE preparation time may be defined based at least in part on the condition triggered functionality validation request or the network confirmation/rejection of functionality validation. The UE preparation time may be defined starting from the time (e.g., slot, subframe, or frame) at which the UE identified that conditions with respect to the functionality are all met, until the time (e.g., slot, subframe, or frame) at which the UE receives the network node confirmation associated with validating the functionality. The UE preparation time may be defined starting from the time (e.g., slot, subframe, or frame) at which the UE transmits its request on validating the functionality, until the time (e.g., slot, subframe, or frame) at which the UE receives the network node confirmation associated with validating the functionality.

In some aspects, the UE preparation time may be defined based at least in part on the implicit functionality validation without the explicit validation request or no network node confirmation/rejection of functionality validation. The UE preparation time may be defined starting from the time (e.g., slot, subframe, or frame) at which the UE identified that conditions with respect to the functionality are all met, until the time (e.g., slot, subframe, or frame) at which both the UE and the network node implicitly agree that the functionality is validated. The UE preparation time may be defined starting from the time (e.g., slot, subframe, or frame) at which the UE transmits an implicit message indicating that all conditions with respect to the functionality are met, until the time (e.g., slot, subframe, or frame) at which both the UE and the network node implicitly agree that the functionality is validated.

In some aspects, the UE preparation time for validating the functionality may be standard predefined, network node configured, and/or UE reported as its capability via RRC signaling during the initial access. The UE may also dynamically update such capabilities via a MAC-CE or DCI.

In some aspects, the functionality may include a first functionality and a second functionality different from the first functionality. The first functionality may be associated with a first set of UE capabilities and the second functionality may be associated with a second set of UE capabilities. The first set of UE capabilities and the second set of UE capabilities may be associated with the UE capability report. The first set of UE capabilities and the second set of UE capabilities may be non-overlapping UE capabilities. The first set of UE capabilities and the second set of UE capabilities may be partially overlapping UE capabilities. The first functionality may be associated with a first set of UE conditions and the second functionality may be associated with a second set of UE conditions. The first set of UE conditions and the second set of UE conditions may be associated with the condition triggered functionality validation request. The first set of UE conditions and the second set of UE conditions may be non-overlapping UE conditions. The first set of UE conditions and the second set of UE conditions may be partially overlapping UE conditions.

In some aspects, the UE capability reporting may be associated with the first functionality and the second functionality, where the second functionality may be different from the first functionality. In a first option associated with orthogonal functionalities and non-overlapping UE capabilities, the first functionality may be associated with the first set of UE capabilities, while the second functionality may be associated with the second set of UE capabilities, where the first set of UE capabilities may be non-overlapping with the second set of UE capabilities. In a second option associated with non-orthogonal functionalities and partial overlapping UE capabilities, the first functionality may be associated with the first set of UE capabilities, while the second functionality may be associated with the second set of UE capabilities, where the first set of UE capabilities may be at least partially overlapping with the second set of UE capabilities.

In an example of the first option, the first functionality may be an L1-RSRP prediction, while the second functionality may be an AI/ML-based CSI compression.

The first set of UE capabilities may be associated with required input parameters for the L1-RSRP prediction, while the second set of UE capabilities may be associated with a required timeline for feedback, such as an AI/ML-based compressed CSI. In an example of the second option, the first functionality may be a time domain beam prediction targeting at least 800 ms later, while the second functionality may be a time domain L1-RSRP prediction targeting no more than 300 ms later. A partially overlapped UE capability may include at least a UE support for the time domain beam prediction, together with the UE's specific capability on a furthest future time domain occasion for which the UE is able to predict an LI-RSRP measurement.

In some aspects, regarding the condition triggered functionality validation request, the first functionality may be different from the second functionality. In a first option associated with orthogonal functionalities and non-overlapping conditions, the first functionality may be associated with the first set of UE conditions, while the second functionality may be associated with the second set of UE conditions, where the first set of UE conditions may be non-overlapping with the second set of UE conditions. In a second option associated with non-orthogonal functionalities and partial overlapping conditions, the first functionality may be associated with the first set of UE conditions, while the second functionality may be associated with the second set of UE conditions, where the first set of UE conditions may be at least partially overlapping with the second set of UE conditions.

In an example of the first option, the first functionality may be an L1-RSRP prediction, while the second functionality may be an AI/ML-based CSI compression. The first set of UE conditions may be associated with measured L1-RSRP levels, while the second set of UE conditions may be associated with measured CQI variation levels. In an example of the second option, the first functionality may be a time domain beam prediction targeting at least 800 ms later, while the second functionality may be a time domain L1-RSRP prediction targeting no more than 300 ms later. Partially overlapped UE conditions may involve currently measured and reported L1-RSRP values regarding target TD prediction resources satisfying a certain value (e.g.,-95 dBm). The first set of UE conditions with respect to the first functionality may further require that an L1-RSRP variation with respect to a same target resource within a past window (e.g., a past 20 second window) should be no greater than a first threshold value (e.g., 3 dB), while conditions with respect to the second functionality may only require no greater than a second threshold value (e.g., 6 dB).

As shown by reference number 504, the UE may perform an action based at least in part on whether the functionality associated with the UE-side AI/ML operation is validated or invalidated in accordance with the UE capability report, the condition triggered functionality validation request, the network confirmation of the functionality validation, and/or the network rejection of the functionality validation. The UE, when performing the action, may perform the functionality based at least in part on the functionality being validated. For example, the UE may perform the time domain beam prediction, the spatial domain beam prediction, the frequency domain beam prediction, the AI/ML based CSI feedback, and/or the AI/ML based positioning, based at least in part on the functionality being validated. Alternatively, the UE, when performing the action, may refrain from performing the functionality based at least in part on the functionality being invalidated.

As indicated above, FIG. 5 is provided as an example. Other examples may differ from what is described with regard to FIG. 5.

FIG. 6 is a diagram illustrating an example process 600 performed, for example, by a UE, in accordance with the present disclosure. Example process 600 is an example where the UE (e.g., UE 120) performs operations associated with validation of functionalities associated with UE-side operations.

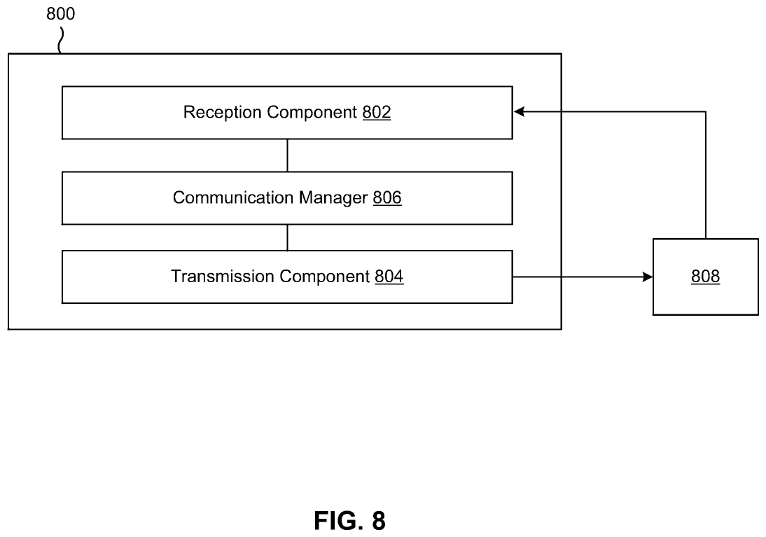

As shown in FIG. 6, in some aspects, process 600 may include transmitting or receiving one or more of: a UE capability report, a condition triggered functionality validation request, a network confirmation of a functionality validation, or a network rejection of the functionality validation, based at least in part on a functionality associated with a UE-side AI/ML operation (block 610). For example, the UE (e.g., using transmission component 804 and/or communication manager 806, depicted in FIG. 8) may transmit or receive one or more of: a UE capability report, a condition triggered functionality validation request, a network confirmation of a functionality validation, or a network rejection of the functionality validation, based at least in part on a functionality associated with a UE-side AI/ML operation, as described above.

As further shown in FIG. 6, in some aspects, process 600 may include performing an action based at least in part on whether the functionality associated with the UE-side AI/ML operation is validated or invalidated in accordance with one or more of: the UE capability report, the condition triggered functionality validation request, the network confirmation of the functionality validation, or the network rejection of the functionality validation (block 620). For example, the UE (e.g., using communication manager 806, depicted in FIG. 8) may perform an action based at least in part on whether the functionality associated with the UE-side AI/ML operation is validated or invalidated in accordance with one or more of: the UE capability report, the condition triggered functionality validation request, the network confirmation of the functionality validation, or the network rejection of the functionality validation, as described above.

Process 600 may include additional aspects, such as any single aspect or any combination of aspects described below and/or in connection with one or more other processes described elsewhere herein.

In a first aspect, process 600 includes transmitting the UE capability report via RRC signaling during an initial access, the functionality being validated based at least in part on the UE capability report indicating that the functionality is supported by the UE.

In a second aspect, alone or in combination with the first aspect, process 600 includes transmitting the condition triggered functionality validation request based at least in part on a condition being satisfied, the condition triggered functionality validation request indicating a request to validate the functionality, the condition being associated with a standard predefinition, a network configuration or indication, or a UE recommendation, and the functionality being validated based at least in part on the condition triggered functionality validation request.

In a third aspect, alone or in combination with one or more of the first and second aspects, process 600 includes receiving the network confirmation of the functionality validation, the network confirmation indicating that the request to validate the functionality is accepted and that the functionality is validated.

In a fourth aspect, alone or in combination with one or more of the first through third aspects, process 600 includes receiving the network rejection of the functionality validation, the network rejection indicating that the request to validate the functionality is rejected and that the functionality is invalidated.

In a fifth aspect, alone or in combination with one or more of the first through fourth aspects, the functionality associated with the UE-side AI/ML operation is one of a time domain beam prediction, a spatial domain beam prediction, a frequency domain beam prediction, an AI/ML based CSI feedback, or an AI/ML based positioning.

In a sixth aspect, alone or in combination with one or more of the first through fifth aspects, process 600 includes determining a UE preparation time for validating the functionality based at least in part on a standard predefinition, a network configuration, or the UE capability report.

In a seventh aspect, alone or in combination with one or more of the first through sixth aspects, the UE preparation time starts at a time associated with a condition with respect to the functionality being satisfied and ends at a time associated with a receipt of the network confirmation of the functionality validation.

In an eighth aspect, alone or in combination with one or more of the first through seventh aspects, the UE preparation time starts at a time associated with a transmission of the condition triggered functionality validation request and ends at a time associated with a receipt of the network confirmation of the functionality validation.

In a ninth aspect, alone or in combination with one or more of the first through eighth aspects, the UE preparation time starts at a time associated with a condition with respect to the functionality being satisfied and ends at a time associated with the functionality being validated.

In a tenth aspect, alone or in combination with one or more of the first through ninth aspects, the UE preparation time starts at a time associated with a transmission of a message indicating that a condition with respect to the functionality is satisfied and ends at a time associated with the functionality being validated.

In an eleventh aspect, alone or in combination with one or more of the first through tenth aspects, the functionality includes a first functionality and a second functionality different from the first functionality.

In a twelfth aspect, alone or in combination with one or more of the first through eleventh aspects, the first functionality is associated with a first set of UE capabilities and the second functionality is associated with a second set of UE capabilities, and the first set of UE capabilities and the second set of UE capabilities are associated with the UE capability report.

In a thirteenth aspect, alone or in combination with one or more of the first through twelfth aspects, the first set of UE capabilities and the second set of UE capabilities are non-overlapping UE capabilities.

In a fourteenth aspect, alone or in combination with one or more of the first through thirteenth aspects, the first set of UE capabilities and the second set of UE capabilities are partially overlapping UE capabilities.

In a fifteenth aspect, alone or in combination with one or more of the first through fourteenth aspects, the first functionality is associated with a first set of UE conditions and the second functionality is associated with a second set of UE conditions, and the first set of UE conditions and the second set of UE conditions are associated with the condition triggered functionality validation request.

In a sixteenth aspect, alone or in combination with one or more of the first through fifteenth aspects, the first set of UE conditions and the second set of UE conditions are non-overlapping UE conditions.

In a seventeenth aspect, alone or in combination with one or more of the first through sixteenth aspects, the first set of UE conditions and the second set of UE conditions are partially overlapping UE conditions.

In an eighteenth aspect, alone or in combination with one or more of the first through seventeenth aspects, process 600 includes performing the functionality based at least in part on the functionality being validated, or refraining from performing the functionality based at least in part on the functionality being invalidated.

Although FIG. 6 shows example blocks of process 600, in some aspects, process 600 may include additional blocks, fewer blocks, different blocks, or differently arranged blocks than those depicted in FIG. 6. Additionally, or alternatively, two or more of the blocks of process 600 may be performed in parallel.

FIG. 7 is a diagram illustrating an example process 700 performed, for example, by a network node, in accordance with the present disclosure. Example process 700 is an example where the network node (e.g., network node 110) performs operations associated with validation of functionalities associated with UE-side operations.

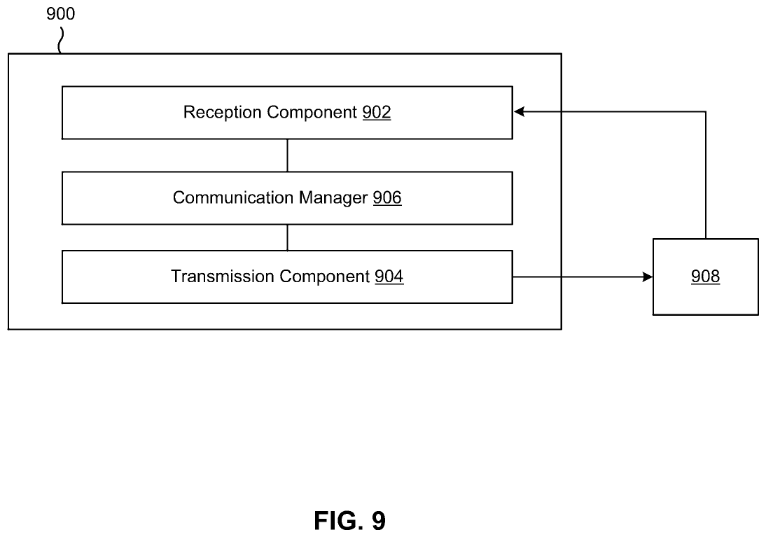

As shown in FIG. 7, in some aspects, process 700 may include transmitting or receiving one or more of: a UE capability report, a condition triggered functionality validation request, a network confirmation of a functionality validation, or a network rejection of the functionality validation, based at least in part on a functionality associated with a UE-side AI/ML operation, and the functionality being validated or invalidated in accordance with one or more of: the UE capability report, the condition triggered functionality validation request, the network confirmation of the functionality validation, or the network rejection of the functionality validation (block 710). For example, the network node (e.g., using transmission component 904 and/or communication manager 906, depicted in FIG. 9) may transmit or receive one or more of: a UE capability report, a condition triggered functionality validation request, a network confirmation of a functionality validation, or a network rejection of the functionality validation, based at least in part on a functionality associated with a UE-side AI/ML operation, and the functionality being validated or invalidated in accordance with one or more of: the UE capability report, the condition triggered functionality validation request, the network confirmation of the functionality validation, or the network rejection of the functionality validation, as described above.

Process 700 may include additional aspects, such as any single aspect or any combination of aspects described below and/or in connection with one or more other processes described elsewhere herein.

In a first aspect, process 700 includes receiving the UE capability report via RRC signaling during an initial access, the functionality being validated based at least in part on the UE capability report indicating that the functionality is supported by the UE.

In a second aspect, alone or in combination with the first aspect, process 700 includes receiving the condition triggered functionality validation request based at least in part on a condition being satisfied, the condition triggered functionality validation request indicating a request to validate the functionality, the condition being associated with a standard predefinition, a network configuration or indication, or a UE recommendation, and the functionality being validated based at least in part on the condition triggered functionality validation request.

In a third aspect, alone or in combination with one or more of the first and second aspects, process 700 includes transmitting the network confirmation of the functionality validation, the network confirmation indicating that the request to validate the functionality is accepted and that the functionality is validated.

In a fourth aspect, alone or in combination with one or more of the first through third aspects, process 700 includes transmitting the network rejection of the functionality validation, the network rejection indicating that the request to validate the functionality is rejected and that the functionality is invalidated.

In a fifth aspect, alone or in combination with one or more of the first through fourth aspects, the functionality associated with the UE-side AI/ML operation is one of a time domain beam prediction, a spatial domain beam prediction, a frequency domain beam prediction, an AI/ML-based CSI feedback, or an AI/ML-based positioning.

In a sixth aspect, alone or in combination with one or more of the first through fifth aspects, a UE preparation time for validating the functionality is based at least in part on a standard predefinition, a network configuration, or the UE capability report.

In a seventh aspect, alone or in combination with one or more of the first through sixth aspects, the UE preparation time starts at a time associated with a condition with respect to the functionality being satisfied and ends at a time associated with a receipt of the network confirmation of the functionality validation.

In an eighth aspect, alone or in combination with one or more of the first through seventh aspects, the UE preparation time starts at a time associated with a transmission of the condition triggered functionality validation request and ends at a time associated with a receipt of the network confirmation of the functionality validation.

In a ninth aspect, alone or in combination with one or more of the first through eighth aspects, the UE preparation time starts at a time associated with a condition with respect to the functionality being satisfied and ends at a time associated with the functionality being validated.

In a tenth aspect, alone or in combination with one or more of the first through ninth aspects, the UE preparation time starts at a time associated with a transmission of a message indicating that a condition with respect to the functionality is satisfied and ends at a time associated with the functionality being validated.

In an eleventh aspect, alone or in combination with one or more of the first through tenth aspects, the functionality includes a first functionality and a second functionality different from the first functionality.

In a twelfth aspect, alone or in combination with one or more of the first through eleventh aspects, the first functionality is associated with a first set of UE capabilities and the second functionality is associated with a second set of UE capabilities, and the first set of UE capabilities and the second set of UE capabilities are associated with the UE capability report.

In a thirteenth aspect, alone or in combination with one or more of the first through twelfth aspects, the first set of UE capabilities and the second set of UE capabilities are non-overlapping UE capabilities.

In a fourteenth aspect, alone or in combination with one or more of the first through thirteenth aspects, the first set of UE capabilities and the second set of UE capabilities are partially overlapping UE capabilities.

In a fifteenth aspect, alone or in combination with one or more of the first through fourteenth aspects, the first functionality is associated with a first set of UE conditions and the second functionality is associated with a second set of UE conditions, and the first set of UE conditions and the second set of UE conditions are associated with the condition triggered functionality validation request.

In a sixteenth aspect, alone or in combination with one or more of the first through fifteenth aspects, the first set of UE conditions and the second set of UE conditions are non-overlapping UE conditions.

In a seventeenth aspect, alone or in combination with one or more of the first through sixteenth aspects, the first set of UE conditions and the second set of UE conditions are partially overlapping UE conditions.

Although FIG. 7 shows example blocks of process 700, in some aspects, process 700 may include additional blocks, fewer blocks, different blocks, or differently arranged blocks than those depicted in FIG. 7. Additionally, or alternatively, two or more of the blocks of process 700 may be performed in parallel.

FIG. 8 is a diagram of an example apparatus 800 for wireless communication, in accordance with the present disclosure. The apparatus 800 may be a UE, or a UE may include the apparatus 800. In some aspects, the apparatus 800 includes a reception component 802, a transmission component 804, and/or a communication manager 806, which may be in communication with one another (for example, via one or more buses and/or one or more other components). In some aspects, the communication manager 806 is the communication manager 140 described in connection with FIG. 1. As shown, the apparatus 800 may communicate with another apparatus 808, such as a UE or a network node (such as a CU, a DU, an RU, or a base station), using the reception component 802 and the transmission component 804.

In some aspects, the apparatus 800 may be configured to perform one or more operations described herein in connection with FIG. 5. Additionally, or alternatively, the apparatus 800 may be configured to perform one or more processes described herein, such as process 600 of FIG. 6. In some aspects, the apparatus 800 and/or one or more components shown in FIG. 8 may include one or more components of the UE described in connection with FIG. 2. Additionally, or alternatively, one or more components shown in FIG. 8 may be implemented within one or more components described in connection with FIG. 2. Additionally, or alternatively, one or more components of the set of components may be implemented at least in part as software stored in a memory. For example, a component (or a portion of a component) may be implemented as instructions or code stored in a non-transitory computer-readable medium and executable by a controller or a processor to perform the functions or operations of the component.

The reception component 802 may receive communications, such as reference signals, control information, data communications, or a combination thereof, from the apparatus 808. The reception component 802 may provide received communications to one or more other components of the apparatus 800. In some aspects, the reception component 802 may perform signal processing on the received communications (such as filtering, amplification, demodulation, analog-to-digital conversion, demultiplexing, deinterleaving, de-mapping, equalization, interference cancellation, or decoding, among other examples), and may provide the processed signals to the one or more other components of the apparatus 800. In some aspects, the reception component 802 may include one or more antennas, a modem, a demodulator, a MIMO detector, a receive processor, a controller/processor, a memory, or a combination thereof, of the UE described in connection with FIG. 2.

The transmission component 804 may transmit communications, such as reference signals, control information, data communications, or a combination thereof, to the apparatus 808. In some aspects, one or more other components of the apparatus 800 may generate communications and may provide the generated communications to the transmission component 804 for transmission to the apparatus 808. In some aspects, the transmission component 804 may perform signal processing on the generated communications (such as filtering, amplification, modulation, digital-to-analog conversion, multiplexing, interleaving, mapping, or encoding, among other examples), and may transmit the processed signals to the apparatus 808. In some aspects, the transmission component 804 may include one or more antennas, a modem, a modulator, a transmit MIMO processor, a transmit processor, a controller/processor, a memory, or a combination thereof, of the UE described in connection with FIG. 2. In some aspects, the transmission component 804 may be co-located with the reception component 802 in a transceiver.

The communication manager 806 may support operations of the reception component 802 and/or the transmission component 804. For example, the communication manager 806 may receive information associated with configuring reception of communications by the reception component 802 and/or transmission of communications by the transmission component 804. Additionally, or alternatively, the communication manager 806 may generate and/or provide control information to the reception component 802 and/or the transmission component 804 to control reception and/or transmission of communications.

The transmission component 804 and/or the reception component 802 may transmit or receive one or more of: a UE capability report, a condition triggered functionality validation request, a network confirmation of a functionality validation, or a network rejection of the functionality validation, based at least in part on a functionality associated with a UE-side AI/ML operation. The communication manager 806 may perform an action based at least in part on whether the functionality associated with the UE-side AI/ML operation is validated or invalidated in accordance with one or more of: the UE capability report, the condition triggered functionality validation request, the network confirmation of the functionality validation, or the network rejection of the functionality validation.

The transmission component 804 may transmit the UE capability report via RRC signaling during an initial access, the functionality being validated based at least in part on the UE capability report indicating that the functionality is supported by the UE. The transmission component 804 may transmit the condition triggered functionality validation request based at least in part on a condition being satisfied, the condition triggered functionality validation request indicating a request to validate the functionality, the condition being associated with a standard predefinition, a network configuration or indication, or a UE recommendation, and the functionality being validated based at least in part on the condition triggered functionality validation request.

The reception component 802 may receive the network confirmation of the functionality validation, the network confirmation indicating that the request to validate the functionality is accepted and that the functionality is validated. The reception component 802 may receive the network rejection of the functionality validation, the network rejection indicating that the request to validate the functionality is rejected and that the functionality is invalidated. The communication manager 806 may determine a UE preparation time for validating the functionality based at least in part on a standard predefinition, a network configuration, or the UE capability report. The communication manager 806 may perform the functionality based at least in part on the functionality being validated, or refrain from performing the functionality based at least in part on the functionality being invalidated.

The number and arrangement of components shown in FIG. 8 are provided as an example. In practice, there may be additional components, fewer components, different components, or differently arranged components than those shown in FIG. 8.

Furthermore, two or more components shown in FIG. 8 may be implemented within a single component, or a single component shown in FIG. 8 may be implemented as multiple, distributed components. Additionally, or alternatively, a set of (one or more) components shown in FIG. 8 may perform one or more functions described as being performed by another set of components shown in FIG. 8.

FIG. 9 is a diagram of an example apparatus 900 for wireless communication, in accordance with the present disclosure. The apparatus 900 may be a network node, or a network node may include the apparatus 900. In some aspects, the apparatus 900 includes a reception component 902, a transmission component 904, and/or a communication manager 906, which may be in communication with one another (for example, via one or more buses and/or one or more other components). In some aspects, the communication manager 906 is the communication manager 150 described in connection with FIG. 1. As shown, the apparatus 900 may communicate with another apparatus 908, such as a UE or a network node (such as a CU, a DU, an RU, or a base station), using the reception component 902 and the transmission component 904.

In some aspects, the apparatus 900 may be configured to perform one or more operations described herein in connection with FIG. 5. Additionally, or alternatively, the apparatus 900 may be configured to perform one or more processes described herein, such as process 700 of FIG. 7. In some aspects, the apparatus 900 and/or one or more components shown in FIG. 9 may include one or more components of the network node described in connection with FIG. 2. Additionally, or alternatively, one or more components shown in FIG. 9 may be implemented within one or more components described in connection with FIG. 2. Additionally, or alternatively, one or more components of the set of components may be implemented at least in part as software stored in a memory. For example, a component (or a portion of a component) may be implemented as instructions or code stored in a non-transitory computer-readable medium and executable by a controller or a processor to perform the functions or operations of the component.

The reception component 902 may receive communications, such as reference signals, control information, data communications, or a combination thereof, from the apparatus 908. The reception component 902 may provide received communications to one or more other components of the apparatus 900. In some aspects, the reception component 902 may perform signal processing on the received communications (such as filtering, amplification, demodulation, analog-to-digital conversion, demultiplexing, deinterleaving, de-mapping, equalization, interference cancellation, or decoding, among other examples), and may provide the processed signals to the one or more other components of the apparatus 900. In some aspects, the reception component 902 may include one or more antennas, a modem, a demodulator, a MIMO detector, a receive processor, a controller/processor, a memory, or a combination thereof, of the network node described in connection with FIG. 2. In some aspects, the reception component 902 and/or the transmission component 904 may include or may be included in a network interface. The network interface may be configured to obtain and/or output signals for the apparatus 900 via one or more communications links, such as a backhaul link, a midhaul link, and/or a fronthaul link.

The transmission component 904 may transmit communications, such as reference signals, control information, data communications, or a combination thereof, to the apparatus 908. In some aspects, one or more other components of the apparatus 900 may generate communications and may provide the generated communications to the transmission component 904 for transmission to the apparatus 908. In some aspects, the transmission component 904 may perform signal processing on the generated communications (such as filtering, amplification, modulation, digital-to-analog conversion, multiplexing, interleaving, mapping, or encoding, among other examples), and may transmit the processed signals to the apparatus 908. In some aspects, the transmission component 904 may include one or more antennas, a modem, a modulator, a transmit MIMO processor, a transmit processor, a controller/processor, a memory, or a combination thereof, of the network node described in connection with FIG. 2. In some aspects, the transmission component 904 may be co-located with the reception component 902 in a transceiver.

The communication manager 906 may support operations of the reception component 902 and/or the transmission component 904. For example, the communication manager 906 may receive information associated with configuring reception of communications by the reception component 902 and/or transmission of communications by the transmission component 904. Additionally, or alternatively, the communication manager 906 may generate and/or provide control information to the reception component 902 and/or the transmission component 904 to control reception and/or transmission of communications.

The transmission component 904 and/or the reception component 902 may transmit or receive one or more of: a UE capability report, a condition triggered functionality validation request, a network confirmation of a functionality validation, or a network rejection of the functionality validation, based at least in part on a functionality associated with a UE-side AI/ML operation, and the functionality being validated or invalidated in accordance with one or more of: the UE capability report, the condition triggered functionality validation request, the network confirmation of the functionality validation, or the network rejection of the functionality validation.

The reception component 902 may receive the UE capability report via RRC signaling during an initial access, the functionality being validated based at least in part on the UE capability report indicating that the functionality is supported by the UE. The reception component 902 may receive the condition triggered functionality validation request based at least in part on a condition being satisfied, the condition triggered functionality validation request indicating a request to validate the functionality, the condition being associated with a standard predefinition, a network configuration or indication, or a UE recommendation, and the functionality being validated based at least in part on the condition triggered functionality validation request.

The transmission component 904 may transmit the network confirmation of the functionality validation, the network confirmation indicating that the request to validate the functionality is accepted and that the functionality is validated. The transmission component 904 may transmit the network rejection of the functionality validation, the network rejection indicating that the request to validate the functionality is rejected and that the functionality is invalidated.

The number and arrangement of components shown in FIG. 9 are provided as an example. In practice, there may be additional components, fewer components, different components, or differently arranged components than those shown in FIG. 9. Furthermore, two or more components shown in FIG. 9 may be implemented within a single component, or a single component shown in FIG. 9 may be implemented as multiple, distributed components. Additionally, or alternatively, a set of (one or more) components shown in FIG. 9 may perform one or more functions described as being performed by another set of components shown in FIG. 9.

The following provides an overview of some Aspects of the present disclosure:
Aspect 1: A method of wireless communication performed by a user equipment (UE), comprising: transmitting or receiving one or more of: a UE capability report, a condition triggered functionality validation request, a network confirmation of a functionality validation, or a network rejection of the functionality validation, based at least in part on a functionality associated with a UE-side artificial intelligence or machine learning (AI/ML) operation; and performing an action based at least in part on whether the functionality associated with the UE-side AI/ML operation is validated or invalidated in accordance with one or more of: the UE capability report, the condition triggered functionality validation request, the network confirmation of the functionality validation, or the network rejection of the functionality validation.
Aspect 2: The method of Aspect 1, wherein transmitting the UE capability report comprises: transmitting the UE capability report via radio resource control (RRC) signaling during an initial access, the functionality being validated based at least in part on the UE capability report indicating that the functionality is supported by the UE.
Aspect 3: The method of any of Aspects 1-2, wherein transmitting the condition triggered functionality validation request comprises: transmitting the condition triggered functionality validation request based at least in part on a condition being satisfied, the condition triggered functionality validation request indicating a request to validate the functionality, the condition being associated with a standard predefinition, a network configuration or indication, or a UE recommendation, and the functionality being validated based at least in part on the condition triggered functionality validation request.
Aspect 4: The method of Aspect 3, wherein receiving the network confirmation of the functionality validation comprises: receiving the network confirmation of the functionality validation, the network confirmation indicating that the request to validate the functionality is accepted and that the functionality is validated.
Aspect 5: The method of Aspect 3, wherein receiving the network rejection of the functionality validation comprises: receiving the network rejection of the functionality validation, the network rejection indicating that the request to validate the functionality is rejected and that the functionality is invalidated.
Aspect 6: The method of any of Aspects 1-5, wherein the functionality associated with the UE-side AI/ML operation is one of: a time domain beam prediction, a spatial domain beam prediction, a frequency domain beam prediction, an AI/ML based channel state information (CSI) feedback, or an AI/ML based positioning.
Aspect 7: The method of any of Aspects 1-6, further comprising: determining a UE preparation time for validating the functionality based at least in part on a standard predefinition, a network configuration, or the UE capability report.
Aspect 8: The method of Aspect 7, wherein the UE preparation time starts at a time associated with a condition with respect to the functionality being satisfied and ends at a time associated with a receipt of the network confirmation of the functionality validation.
Aspect 9: The method of Aspect 7, wherein the UE preparation time starts at a time associated with a transmission of the condition triggered functionality validation request and ends at a time associated with a receipt of the network confirmation of the functionality validation.
Aspect 10: The method of Aspect 7, wherein the UE preparation time starts at a time associated with a condition with respect to the functionality being satisfied and ends at a time associated with the functionality being validated.
Aspect 11: The method of Aspect 7, wherein the UE preparation time starts at a time associated with a transmission of a message indicating that a condition with respect to the functionality is satisfied and ends at a time associated with the
Aspect 12: The method of any of Aspects 1-11, wherein the functionality includes a first functionality and a second functionality different from the first functionality.
Aspect 13: The method of Aspect 12, wherein the first functionality is associated with a first set of UE capabilities and the second functionality is associated with a second set of UE capabilities, and the first set of UE capabilities and the second set of UE capabilities are associated with the UE capability report.
Aspect 14: The method of Aspect 13, wherein the first set of UE capabilities and the second set of UE capabilities are non-overlapping UE capabilities.
Aspect 15: The method of Aspect 13, wherein the first set of UE capabilities and the second set of UE capabilities are partially overlapping UE capabilities.
Aspect 16: The method of Aspect 12, wherein the first functionality is associated with a first set of UE conditions and the second functionality is associated with a second set of UE conditions, and the first set of UE conditions and the second set of UE conditions are associated with the condition triggered functionality validation request.
Aspect 17: The method of Aspect 16, wherein the first set of UE conditions and the second set of UE conditions are non-overlapping UE conditions.
Aspect 18: The method of Aspect 16, wherein the first set of UE conditions and the second set of UE conditions are partially overlapping UE conditions.
Aspect 19: The method of Aspect 1, wherein performing the action comprises: performing the functionality based at least in part on the functionality being validated; or refraining from performing the functionality based at least in part on the functionality being invalidated.
Aspect 20: A method of wireless communication performed by a network node, comprising: transmitting or receiving one or more of: a user equipment (UE) capability report, a condition triggered functionality validation request, a network confirmation of a functionality validation, or a network rejection of the functionality validation, based at least in part on a functionality associated with a UE-side artificial intelligence or machine learning (AI/ML) operation, and the functionality being validated or invalidated in accordance with one or more of: the UE capability report, the condition triggered functionality validation request, the network confirmation of the functionality validation, or the network rejection of the functionality validation.
Aspect 21: The method of Aspect 20, wherein receiving the UE capability report comprises: receiving the UE capability report via radio resource control (RRC) signaling during an initial access, the functionality being validated based at least in part on the UE capability report indicating that the functionality is supported by the UE.
Aspect 22: The method of any of Aspects 20-21, wherein receiving the condition triggered functionality validation request comprises: receiving the condition triggered functionality validation request based at least in part on a condition being satisfied, the condition triggered functionality validation request indicating a request to validate the functionality, the condition being associated with a standard predefinition, a network configuration or indication, or a UE recommendation, and the functionality being validated based at least in part on the condition triggered functionality validation request.
Aspect 23: The method of Aspect 22, wherein transmitting the network confirmation of the functionality validation comprises: transmitting the network confirmation of the functionality validation, the network confirmation indicating that the request to validate the functionality is accepted and that the functionality is validated.
Aspect 24: The method of Aspect 22, wherein transmitting the network rejection of the functionality validation comprises: transmitting the network rejection of the functionality validation, the network rejection indicating that the request to validate the functionality is rejected and that the functionality is invalidated.
Aspect 25: The method of any of Aspects 20-24, wherein the functionality associated with the UE-side AI/ML operation is one of: a time domain beam prediction, a spatial domain beam prediction, a frequency domain beam prediction, an AI/ML based channel state information (CSI) feedback, or an AI/ML based positioning.
Aspect 26: The method of any of Aspects 20-25, wherein a UE preparation time for validating the functionality is based at least in part on a standard predefinition, a network configuration, or the UE capability report.
Aspect 27: The method of Aspect 26, wherein the UE preparation time starts at a time associated with a condition with respect to the functionality being satisfied and ends at a time associated with a receipt of the network confirmation of the functionality validation.
Aspect 28: The method of Aspect 26, wherein the UE preparation time starts at a time associated with a transmission of the condition triggered functionality validation request and ends at a time associated with a receipt of the network confirmation of the functionality validation.
Aspect 29: The method of Aspect 26, wherein the UE preparation time starts at a time associated with a condition with respect to the functionality being satisfied and ends at a time associated with the functionality being validated.
Aspect 30: The method of Aspect 26, wherein the UE preparation time starts at a time associated with a transmission of a message indicating that a condition with respect to the functionality is satisfied and ends at a time associated with the functionality being validated.
Aspect 31: The method of any of Aspects 20-30, wherein the functionality includes a first functionality and a second functionality different from the first functionality.
Aspect 32: The method of Aspect 31, wherein the first functionality is associated with a first set of UE capabilities and the second functionality is associated with a second set of UE capabilities, and the first set of UE capabilities and the second set of UE capabilities are associated with the UE capability report.
Aspect 33: The method of Aspect 32, wherein the first set of UE capabilities and the second set of UE capabilities are non-overlapping UE capabilities.
Aspect 34: The method of Aspect 32, wherein the first set of UE capabilities and the second set of UE capabilities are partially overlapping UE capabilities.
Aspect 35: The method of Aspect 31, wherein the first functionality is associated with a first set of UE conditions and the second functionality is associated with a second set of UE conditions, and the first set of UE conditions and the second set of UE conditions are associated with the condition triggered functionality validation request.
Aspect 36: The method of Aspect 35, wherein the first set of UE conditions and the second set of UE conditions are non-overlapping UE conditions.
Aspect 37: The method of Aspect 35, wherein the first set of UE conditions and the second set of UE conditions are partially overlapping UE conditions.
Aspect 38: An apparatus for wireless communication at a device, comprising a processor; memory coupled with the processor; and instructions stored in the memory and executable by the processor to cause the apparatus to perform the method of one or more of Aspects 1-19.
Aspect 39: A device for wireless communication, comprising a memory and one or more processors coupled to the memory, the one or more processors configured to perform the method of one or more of Aspects 1-19.
Aspect 40: An apparatus for wireless communication, comprising at least one means for performing the method of one or more of Aspects 1-19.
Aspect 41: A non-transitory computer-readable medium storing code for wireless communication, the code comprising instructions executable by a processor to perform the method of one or more of Aspects 1-19.
Aspect 42: A non-transitory computer-readable medium storing a set of instructions for wireless communication, the set of instructions comprising one or more instructions that, when executed by one or more processors of a device, cause the device to perform the method of one or more of Aspects 1-19.
Aspect 43: An apparatus for wireless communication at a device, comprising a processor; memory coupled with the processor; and instructions stored in the memory and executable by the processor to cause the apparatus to perform the method of one or more of Aspects 20-37.
Aspect 44: A device for wireless communication, comprising a memory and one or more processors coupled to the memory, the one or more processors configured to perform the method of one or more of Aspects 20-37.
Aspect 45: An apparatus for wireless communication, comprising at least one means for performing the method of one or more of Aspects 20-37.
Aspect 46: A non-transitory computer-readable medium storing code for wireless communication, the code comprising instructions executable by a processor to perform the method of one or more of Aspects 20-37.
Aspect 47: A non-transitory computer-readable medium storing a set of instructions for wireless communication, the set of instructions comprising one or more instructions that, when executed by one or more processors of a device, cause the device to perform the method of one or more of Aspects 20-37.

The foregoing disclosure provides illustration and description but is not intended to be exhaustive or to limit the aspects to the precise forms disclosed. Modifications and variations may be made in light of the above disclosure or may be acquired from practice of the aspects.

As used herein, the term “component” is intended to be broadly construed as hardware and/or a combination of hardware and software. “Software” shall be construed broadly to mean instructions, instruction sets, code, code segments, program code, programs, subprograms, software modules, applications, software applications, software packages, routines, subroutines, objects, executables, threads of execution, procedures, and/or functions, among other examples, whether referred to as software, firmware, middleware, microcode, hardware description language, or otherwise. As used herein, a “processor” is implemented in hardware and/or a combination of hardware and software. It will be apparent that systems and/or methods described herein may be implemented in different forms of hardware and/or a combination of hardware and software. The actual specialized control hardware or software code used to implement these systems and/or methods is not limiting of the aspects. Thus, the operation and behavior of the systems and/or methods are described herein without reference to specific software code, since those skilled in the art will understand that software and hardware can be designed to implement the systems and/or methods based, at least in part, on the description herein.

As used herein, “satisfying a threshold” may, depending on the context, refer to a value being greater than the threshold, greater than or equal to the threshold, less than the threshold, less than or equal to the threshold, equal to the threshold, not equal to the threshold, or the like.

Even though particular combinations of features are recited in the claims and/or disclosed in the specification, these combinations are not intended to limit the disclosure of various aspects. Many of these features may be combined in ways not specifically recited in the claims and/or disclosed in the specification. The disclosure of various aspects includes each dependent claim in combination with every other claim in the claim set. As used herein, a phrase referring to “at least one of” a list of items refers to any combination of those items, including single members. As an example, “at least one of: a, b, or c” is intended to cover a, b, c, a+b, a+c, b+c, and a+b+c, as well as any combination with multiples of the same element (e.g., a+a, a+a+a, a+a+b, a+a+c, a+b+b, a+c+c, b+b, b+b+b, b+b+c, c+c, and c+c+c, or any other ordering of a, b, and c).

No element, act, or instruction used herein should be construed as critical or essential unless explicitly described as such. Also, as used herein, the articles “a” and “an” are intended to include one or more items and may be used interchangeably with “one or more.” Further, as used herein, the article “the” is intended to include one or more items referenced in connection with the article “the” and may be used interchangeably with “the one or more.” Furthermore, as used herein, the terms “set” and “group” are intended to include one or more items and may be used interchangeably with “one or more.” Where only one item is intended, the phrase “only one” or similar language is used. Also, as used herein, the terms “has,” “have,” “having,” or the like are intended to be open-ended terms that do not limit an element that they modify (e.g., an element “having” A may also have B). Further, the phrase “based on” is intended to mean “based, at least in part, on” unless explicitly stated otherwise. Also, as used herein, the term “or” is intended to be inclusive when used in a series and may be used interchangeably with “and/or,” unless explicitly stated otherwise (e.g., if used in combination with “either” or “only one of”).

1. An apparatus for wireless communication at a user equipment (UE), comprising:
a memory; and
one or more processors, coupled to the memory, configured to:
transmit or receive one or more of: a UE capability report, a condition triggered functionality validation request, a network confirmation of a functionality validation, or a network rejection of the functionality validation, based at least in part on a functionality associated with a UE-side artificial intelligence or machine learning (AI/ML) operation; and
perform an action based at least in part on whether the functionality associated with the UE-side AI/ML operation is validated or invalidated in accordance with one or more of: the UE capability report, the condition triggered functionality validation request, the network confirmation of the functionality validation, or the network rejection of the functionality validation.

2. The apparatus of claim 1, wherein the one or more processors are configured to transmit the UE capability report via radio resource control (RRC) signaling during an initial access, the functionality being validated based at least in part on the UE capability report indicating that the functionality is supported by the UE.

3. The apparatus of claim 1, wherein the one or more processors are configured to transmit the condition triggered functionality validation request based at least in part on a condition being satisfied, the condition triggered functionality validation request indicating a request to validate the functionality, the condition being associated with a standard predefinition, a network configuration or indication, or a UE recommendation, and the functionality being validated based at least in part on the condition triggered functionality validation request.

4. The apparatus of claim 3, wherein the one or more processors are configured to receive the network confirmation of the functionality validation, the network confirmation indicating that the request to validate the functionality is accepted and that the functionality is validated.

5. The apparatus of claim 3, wherein the one or more processors are configured to receive the network rejection of the functionality validation, the network rejection indicating that the request to validate the functionality is rejected and that the functionality is invalidated.

6. The apparatus of claim 1, wherein the functionality associated with the UE-side AI/ML operation is one of: a time domain beam prediction, a spatial domain beam prediction, a frequency domain beam prediction, an AI/ML based channel state information (CSI) feedback, or an AI/ML based positioning.

7. The apparatus of claim 1, wherein the one or more processors are further configured to:
determine a UE preparation time for validating the functionality based at least in part on a standard predefinition, a network configuration, or the UE capability report.

8. The apparatus of claim 7, wherein the UE preparation time starts at a time associated with a condition with respect to the functionality being satisfied and ends at a time associated with a receipt of the network confirmation of the functionality validation.

9. The apparatus of claim 7, wherein the UE preparation time starts at a time associated with a transmission of the condition triggered functionality validation request and ends at a time associated with a receipt of the network confirmation of the functionality validation.

10. The apparatus of claim 7, wherein the UE preparation time starts at a time associated with a condition with respect to the functionality being satisfied and ends at a time associated with the functionality being validated.

11. The apparatus of claim 7, wherein the UE preparation time starts at a time associated with a transmission of a message indicating that a condition with respect to the functionality is satisfied and ends at a time associated with the functionality being validated.

12. The apparatus of claim 1, wherein the functionality includes a first functionality and a second functionality different from the first functionality.

13. The apparatus of claim 12, wherein the first functionality is associated with a first set of UE capabilities and the second functionality is associated with a second set of UE capabilities, and the first set of UE capabilities and the second set of UE capabilities are associated with the UE capability report.

14. The apparatus of claim 13, wherein the first set of UE capabilities and the second set of UE capabilities are non-overlapping UE capabilities.

15. (canceled)

16. The apparatus of claim 12, wherein the first functionality is associated with a first set of UE conditions and the second functionality is associated with a second set of UE conditions, and the first set of UE conditions and the second set of UE conditions are associated with the condition triggered functionality validation request.

17. The apparatus of claim 16, wherein the first set of UE conditions and the second set of UE conditions are non-overlapping UE conditions.

18. The apparatus of claim 16, wherein the first set of UE conditions and the second set of UE conditions are partially overlapping UE conditions.

19. The apparatus of claim 1, wherein the one or more processors, to perform the action, are configured to:
perform the functionality based at least in part on the functionality being validated; or
refrain from performing the functionality based at least in part on the functionality being invalidated.

20. An apparatus for wireless communication at a network node, comprising:
a memory; and
one or more processors, coupled to the memory, configured to:
transmit or receive one or more of: a user equipment (UE) capability report, a condition triggered functionality validation request, a network confirmation of a functionality validation, or a network rejection of the functionality validation, based at least in part on a functionality associated with a UE-side artificial intelligence or machine learning (AI/ML) operation, and the functionality being validated or invalidated in accordance with one or more of: the UE capability report, the condition triggered functionality validation request, the network confirmation of the functionality validation, or the network rejection of the functionality validation.

21-37. (canceled)

38. A method of wireless communication performed by a user equipment (UE), comprising:
transmitting or receiving one or more of: a UE capability report, a condition triggered functionality validation request, a network confirmation of a functionality validation, or a network rejection of the functionality validation, based at least in part on a functionality associated with a UE-side artificial intelligence or machine learning (AI/ML) operation; and
performing an action based at least in part on whether the functionality associated with the UE-side AI/ML operation is validated or invalidated in accordance with one or more of: the UE capability report, the condition triggered functionality validation request, the network confirmation of the functionality validation, or the network rejection of the functionality validation.

39-78. (canceled)
